(19) United States
(12) Patent Application Publication
(10) Pub. No.: US 2026/0057285 A1
(43) Pub. Date: Feb. 26, 2026

(54) PERSONALIZED PATTERN-BASED DEVICE CONTROL SYSTEM AND DEVICE CONTROL METHOD

(71) Applicant: SOS LAB Co., Ltd., Gwangju (KR)

(72) Inventors: Ji Seong JEONG, Gwangju (KR); Jun Hwan JANG, Yongin-si (KR); Jaekwon LEE, Gwangju (KR); Junho CHOI, Gwangju (KR)

(21) Appl. No.: 18/809,818

(22) Filed: Aug. 20, 2024

(30) Foreign Application Priority Data
Jun. 28, 2023 (KR) 10-2023-0083294

(51) Int. Cl. G06N 20/00; G05B 15/02

(52) U.S. Cl. CPC G06N 20/00; G05B 15/02; G05B 2219/2642

(57) ABSTRACT

Proposed is a method for training a motion prediction model. The method may include obtaining sensor data including a plurality of frame data, and obtaining home appliance data including operation time information for a first operation of a home appliance. The method may also include selecting a frame data group on the basis of the operation time information for a first operation of the home appliance included in the home appliance data and time information for each of the plurality of frame data. The method may further include generating training input data for the first operation of the home appliance on the basis of the selected frame data group, and training the motion prediction system using at least the training input data.

### CROSS REFERENCE TO RELATED APPLICATION AND ASSOCIATED PROJECT

The present application claims priority to Korean Patent Applications No. 10-2023-0083294, filed on Jun., 28, 2023 the entire contents of which are incorporated herein for all purposes by this reference. This application is also associated with a project entitled “Development of integrated platform technology for fire and disaster management in underground utility tunnel based on digital twin” as project number RS-2020-II200061.

### BACKGROUND

### Technical Field

The present disclosure relates to a customized motion prediction model that is trained directly using training data based on the life of a user rather than using an AI model that is trained in advance to predict operations of home appliances and then distributed, and relates to a home appliance motion prediction system.

In more detail, the present disclosure relates to a system that can collect and generate training data for a predetermined period after distributed to users, train a motion prediction model using the collected and generated training data, obtain motion prediction information for home appliances using the trained motion prediction model, and control the home appliances using the obtained motion prediction information.

### Description of Related Technology

In relation to systems that predicts whether a user will operate a surrounding device on the basis of the user's behavior and that automatically operates the surrounding device on the basis of the prediction result, existing systems first determined the meaning of user's behavior by sensing the behavior and then operated devices in accordance with preset rules on the basis of the meaning of the behavior.

### SUMMARY

An objective of the present disclosure is to collect and generate training data for a predetermined period after a system is distributed to a user.

Another objective of the present disclosure is to train a motion prediction model using collected and generated training data.

Another objective of the present disclosure is to obtain motion prediction information for home appliances using a trained motion prediction model and to control the home appliances using the obtained motion prediction information.

Objectives of the present disclosure are not limited to those described above and objectives not stated above will be clearly understood to those skilled in the art from the specification and the accompanying drawings.

According to one embodiment of the present disclosure, there is provided a method for training a motion prediction model, comprising: obtaining a sensor data comprising a plurality of frame data, wherein the sensor data comprises a time information for each of the plurality of frame data, wherein each of the plurality of frame data comprises a plurality of point data, wherein each of the plurality of point data comprises a position coordinate value, obtaining a first home appliance data comprising an operation time information for a first operation of a first home appliance, selecting a first frame data group based on the operation time information for the first operation of the first home appliance included in the first home appliance data and the time information for each of the plurality of frame data, wherein the first frame data group comprises at least two or more frame data, wherein a time information for the at least two or more frame data included in the first frame data group indicates times earlier than the operation time information for the first operation, generating a first training input data for the first operation of the first home appliance based on the first frame data group and training a first motion prediction model for the first home appliance using at least the first training input data.

According to another embodiment of the present disclosure, there is provided a method for operating a motion prediction system that generates motion control information for home appliances after a training data collection period once installed in the user's home, comprising: generating a trained motion prediction model, wherein the trained motion prediction model is trained using training data generated based on sensor data obtained in the training data collection period and generating operation control information for the home appliances by applying prediction input data to the trained operation prediction model, wherein the prediction input data is generated based on sensor data obtained in an operation prediction period after the training data collection period, wherein in the training data collection period, the motion prediction system operates as follows: obtaining sensor data comprising a plurality of frame data, wherein each of the plurality of frame data comprises a plurality of point data, wherein each of the plurality of point data comprises a position coordinate value, obtaining a home appliance data comprising an operation time information for a first operation of the home appliances, selecting a first frame data group comprising at least two or more frame data among the plurality of frame data using the operation time information for the first operation of the home appliances included in the home appliance data and generating a training data by generating a training input data for the first operation of the home appliances based on the first frame data group,

In this case, in the operation prediction period, the motion prediction system operates as follows: obtaining sensor data comprising a plurality of frame data, wherein each of the plurality of frame data comprises a plurality of point data, wherein each of the plurality of point data comprises a position coordinate value, selecting a second frame data group comprising at least two or more frame data among the plurality of frame data, generating a prediction input data based on the second frame data group and generating an operation control information for the home appliances by applying the prediction input data to the trained motion prediction model.

Objectives of the present disclosure are not limited to those described above and objectives not stated above will be clearly understood to those skilled in the art from the specification and the accompanying drawings.

According to an embodiment of the present disclosure, a system that collects and generates training data for a predetermined period after the system is distributed to a user can be provided.

According to another embodiment of the present disclosure, a system that trains a motion prediction model using collected and generated training data can be provided.

According to another embodiment of the present disclosure, a system that obtains motion prediction information for home appliances using a trained motion prediction model and controls the home appliances using the obtained motion prediction information.

Effects of the present disclosure are not limited to those described above and effects not stated above will be clearly understood to those skilled in the art from the specification and the accompanying drawings.

### BRIEF DESCRIPTION OF THE DRAWINGS

FIG. 1 is a diagram showing a home appliance motion prediction system according to an embodiment;

FIG. 2 is a diagram showing sensor data according to an embodiment;

FIG. 3 is a diagram illustrating a motion prediction system according to an embodiment;

FIG. 4 is a diagram illustrating a method of generating training data according to an embodiment;

FIG. 5 is a diagram illustrating in detail a method of selecting a frame data group according to an embodiment;

FIG. 6 is a diagram illustrating a method of generating training data according to an embodiment;

FIGS. 7 to 9 are diagrams illustrating a method of training a motion prediction model according to an embodiment;

FIG. 10 is a diagram illustrating a method of generating operation control information according to an embodiment;

FIG. 11 is a diagram illustrating a method of generating operation control information according to an embodiment;

FIG. 12 is a diagram illustrating a method of generating operation control information according to an embodiment;

FIG. 13 is a diagram illustrating a motion prediction system according to an embodiment;

FIG. 14 is a diagram illustrating a method of generating training data according to an embodiment;

FIG. 15 is a diagram illustrating a method of training a motion prediction model according to an embodiment; and

FIG. 16 is a diagram illustrating a method of generating operation control information according to an embodiment.

### DETAILED DESCRIPTION

Existing systems use a user behavior recognition model to determine the meaning of behavior of users. A user behavior recognition model is a model that predicts what behavior the movements of a user mean from the movement of the user. For example, a user behavior recognition model is a model that takes input of movement information of a user and outputs behavior information of the user such as whether the user is walking, is sitting, or waved his/her hand.

A user behavior recognition model needs movement data of a user and behavior data corresponding to the movements in order to be trained. Accordingly, a user behavior recognition model should be trained and stored in a system in advance. In detail, even though movement data of a user can be obtained after a system is distributed to the user, the obtained user movement data cannot realistically be annotated to indicate what kind of behavior it represents. This is because training data for training a user behavior recognition model cannot be obtained after a system is distributed to a user.

Accordingly, existing systems have a problem that they cannot apply movement features of users because they use a same user behavior recognition model without distinguishing users.

Embodiments described herein are provided to clearly explain the spirit of the present disclosure to those skilled in the art, so the present disclosure is not limited to the embodiments described herein and the scope of the present disclosure should be construed as including changed or modified examples not departing from the spirit of the present disclosure.

Terminologies used herein were selected from general terminologies that are used at present as generally as possible in consideration of their functions herein, but may be changed, depending on the intention of those skilled in the art, precedents, the advent of new technologies, or the like. However, when such specific terminologies are defined and used as certain meanings, the meanings of the terminologies will be specifically described. Accordingly, the terminologies used herein should be construed on the basis of the substantial meanings of the terminologies and the entire specification, not simply the names of the terminologies.

When it is determined that detailed description of well-known configurations or functions related to the present disclosure may make the spirit of the present disclosure unclear, they are not described in detail, if necessary.

Numbers (e.g., first, second, etc.) used in the description of the present disclosure are only identification symbols to discriminate one component from another component.

In the following embodiments, singular forms are intended to include plural forms unless the context clearly indicates otherwise.

In the following embodiments, terms such as “include”, “have” or “comprise” mean that the features or components described herein exist without excluding the possibility that one or more other features or components are added.

When an embodiment can be implemented in another way, specific processes may be performed in order different from the description. For example, two sequentially described processes may be substantially simultaneously performed or may be performed in the reverse order of the described order.

The accompanying drawings of the present disclosure are provided for easy description of the present disclosure and the shapes shown in the drawings may be exaggerated to help understand the present disclosure, if necessary, so the present disclosure is not limited to the drawings of the present disclosure.

According to one embodiment of the present disclosure, there is provided a method for training a motion prediction model, comprising: obtaining a sensor data comprising a plurality of frame data, wherein the sensor data comprises a time information for each of the plurality of frame data, wherein each of the plurality of frame data comprises a plurality of point data, wherein each of the plurality of point data comprises a position coordinate value, obtaining a first home appliance data comprising an operation time information for a first operation of a first home appliance, selecting a first frame data group based on the operation time information for the first operation of the first home appliance included in the first home appliance data and the time information for each of the plurality of frame data, wherein the first frame data group comprises at least two or more frame data, wherein a time information for the at least two or more frame data included in the first frame data group indicates times earlier than the operation time information for the first operation, generating a first training input data for the first operation of the first home appliance based on the first frame data group and training a first motion prediction model for the first home appliance using at least the first training input data.

According to another embodiment of the present disclosure, there is provided a method for operating a motion prediction system that generates motion control information for home appliances after a training data collection period once installed in the user's home, comprising: generating a trained motion prediction model, wherein the trained motion prediction model is trained using training data generated based on sensor data obtained in the training data collection period and generating operation control information for the home appliances by applying prediction input data to the trained operation prediction model, wherein the prediction input data is generated based on sensor data obtained in an operation prediction period after the training data collection period.

In this case, in the training data collection period, the motion prediction system operates as follows: obtaining sensor data comprising a plurality of frame data, wherein each of the plurality of frame data comprises a plurality of point data, wherein each of the plurality of point data comprises a position coordinate value, obtaining a home appliance data comprising an operation time information for a first operation of the home appliances, selecting a first frame data group comprising at least two or more frame data among the plurality of frame data using the operation time information for the first operation of the home appliances included in the home appliance data and generating a training data by generating a training input data for the first operation of the home appliances based on the first frame data group,

In this case, in the operation prediction period, the motion prediction system operates as follows: obtaining sensor data comprising a plurality of frame data, wherein each of the plurality of frame data comprises a plurality of point data, wherein each of the plurality of point data comprises a position coordinate value, selecting a second frame data group comprising at least two or more frame data among the plurality of frame data, generating a prediction input data based on the second frame data group and generating an operation control information for the home appliances by applying the prediction input data to the trained motion prediction model.

A home appliance motion prediction system 100 of the present disclosure is described hereafter.

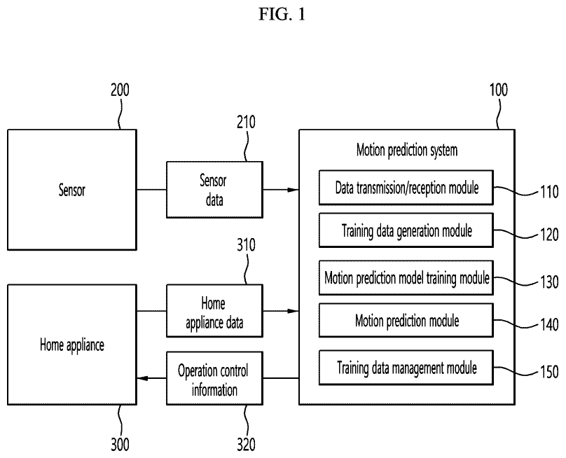

FIG. 1 is a diagram showing a home appliance motion prediction system 100 according to an embodiment of the present disclosure.

A home appliance motion prediction system 100 according to an embodiment of the present disclosure may be a system that predicts an operation of a home appliance 300 using sensor data 210 obtained from at least one sensor 200.

The home appliance motion prediction system 100 according to an embodiment of the present disclosure may be a system that predicts an operation of a home appliance 300 by applying sensor data 210 obtained from at least one sensor 200 to a trained motion prediction model.

The home appliance motion prediction system 100 according to an embodiment of the present disclosure may be a system further including a configuration for generating training data for training a motion prediction model for predicting an operation of the home appliance 300 using sensor data 210 obtained from at least one sensor 200, and for training the motion prediction model using the generated training data.

This may be because it is an objective to provide a customized system by directly collecting and generating training data based on the life of a user rather than the home appliance motion prediction system 100 according to an embodiment of the present disclosure uses an AI model that is distributed after training in advance, but the present disclosure is not limited thereto.

That is, the home appliance motion prediction system 100 according to an embodiment of the present disclosure may mean a system that can collect and generate training data for a predetermined period after distributed to users, train a motion prediction model using the collected and generated training data, obtain motion prediction information for home appliances using the trained motion prediction model, and control the home appliances using the obtained motion prediction information, but is not limited thereto.

The home appliance motion prediction system 100 according to an embodiment of the present disclosure includes various configurations for implementing the operations described above, which will be described in more detail below.

The home appliance motion prediction system 100 according to an embodiment of the present disclosure uses sensor data 210 obtained from at least one sensor 200 and home appliance data 310 obtained from at least one home appliance 300 and can output information for controlling the operation of the at least one home appliance, so this will be described in detail and then various configurations for implementing the home appliance motion prediction system 100 according to an embodiment of the present disclosure will be described.

Meanwhile, the configuration referred to as the home appliance 300 in the present disclosure is referred to as a home appliance for the convenience of description, and a configuration referred to as a home appliance in the present disclosure may be applied to various kinds of electronic devices and/or electric devices as well that can interact with users. However, various kinds of electronic devices and/or electric devices that can interact with a user are hereafter referred to as term “home appliance” for the convenience of description in the present disclosure, and unless there is no specific circumstances, configurations referred to as home appliances below can be understood as various electronic devices and/or electric devices that can interact with users.

In this case, various kinds of electronic devices and/or electric devices that can interact with users may include devices that can interact with a user at various facilities such as an office space, an educational space, and/or a factory.

In particular, various kinds of electronic devices and/or electric devices that can interact with users can be understood as devices that can interact with users in various spaces such as a home where a small number of people reside and/or occupy or live, an office space, an educational space, or a factory.

For example, a device in an office space may include a printer, a scanner, a fax machine, a copier, a computer, a laptop, a monitor, a lighting device, an air handling unit, an air purifier, a phone, a network switch, a modem, a router, a beam projector, an air conditioner, a heater, a coffee machine, etc., and is not limited thereto.

For example, a device in an educational space may include an interactive whiteboard, a beam projector, a touch screen, a web camera, a microphone, an educational console, an electronic book, an IoT device, a motion sensing device, a voice recognition device, a computer, a laptop, a tablet, a monitor, a lighting device, and air handling unit, an air purifier, an air conditioner, a heater, etc., and is not limited thereto.

For example, a device in a factory may include a conveyer belt, a robot arm, a loader, a conveyor, a press machine, a cutting machine, a grinding machine, a power generator, an electrical panel, an electrical switch, an electric motor, a lighting device, an air handling unit, an access control system, an interphone, etc., and is not limited thereto.

The sensor 200 according to an embodiment may include a LiDAR device.

The LiDAR device described herein can be understood as a concept including various devices that measure a distance using a laser. For example, the LiDAR device can be understood as a concept including a Light Detection And Ranging (LiDAR) and/or Time-of-Flight (TOF) sensor, etc., but is not limited thereto.

The LiDAR device according to an embodiment may be a device for detecting the distance from an object and the position of the object using a laser.

For example, the LiDAR device can output a laser, and when an output laser reflects from an object, the LiDAR device can measure the distance between the object and the LiDAR device and the position of the object.

In this case, the object may mean at least one object. The object is not limited thereto and may mean a portion of an object for reflecting at least a portion of a laser output from the LiDAR device.

The sensor 200 according to an embodiment may include a LiDAR device that measures the distance from an object using various methods.

For example, the sensor 200 may include a LiDAR device that uses a Time Of Flight (TOF) of a laser until the laser is sensed after output, a LiDAR device that uses a triangulation method, a LIDAR device that uses an interferometry method, and/or a LiDAR device that uses phase shift measurement, etc. The sensor 200 is not limited thereto and may include various LiDAR devices that are generally understood as a LiDAR device.

The sensor 200 according to an embodiment may include LiDAR devices with various structures.

For example, the sensor 200 may include a spinning-type LiDAR device that rotates a laser output unit and a laser detecting unit, a mechanical-type LiDAR device that drives at least one optical unit for reflecting a laser, and/or a solid-state-type LiDAR device without a mechanical rotary configuration, etc. The sensor 200 is not limited thereto and may include various LiDAR devices that are generally understood as a LiDAR device.

The sensor 200 according to an embodiment may generate sensor data 210.

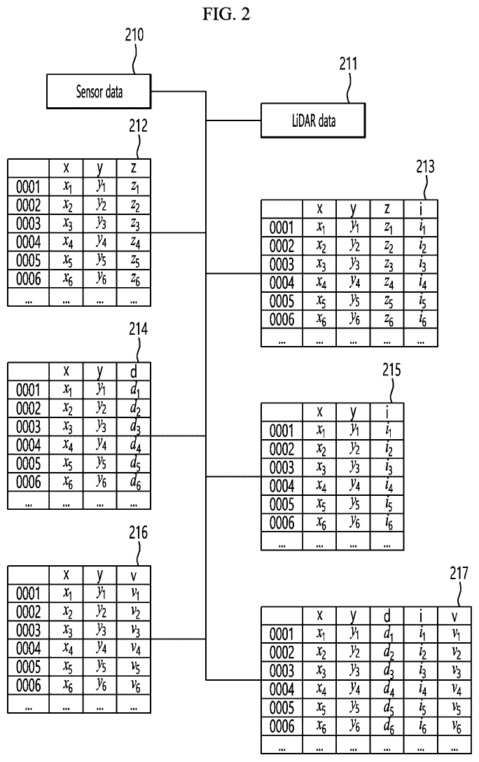

FIG. 2 is a diagram showing sensor data 210 according to an embodiment. Hereafter, the sensor data 210 according to an embodiment is described with reference to FIG. 2.

The sensor data 210 according to an embodiment may include at least one piece of point data.

The sensor data 210 according to an embodiment may include LiDAR data 211 including at least one piece of point data.

The sensor data 210 according to an embodiment may include point cloud data 212 including at least one piece of point data. In this case, the at least one piece of point data may include 3D position coordinates (X, Y, Z) and is not limited thereto.

The sensor data 210 according to an embodiment may include point cloud data 213 including at least one piece of point data. In this case, the at least one piece of point data may include 3D position coordinates (X, Y, Z) and an intensity value i, and is not limited thereto.

The sensor data 210 according to an embodiment may include depth map data 214 including at least one piece of point data. In this case, the at least one piece of point data may include 2D position coordinates (X, Y) and a depth value d, and is not limited thereto.

The sensor data 210 according to an embodiment may include intensity map data 215 including at least one piece of point data. In this case, the at least one piece of point data may include 2D position coordinates (X, Y) and an intensity value i, and is not limited thereto.

The sensor data 210 according to an embodiment may include light capture map data 216 including at least one piece of point data. In this case, the at least one piece of point data may include 2D position coordinates (X, Y) and a light capture value v, and is not limited thereto.

The sensor data 210 according to an embodiment may include detecting map data 217 including at least one piece of point data. In this case, the at least one piece of point data may include 2D position coordinates (X, Y), a depth value d, an intensity value i, and a light capture value v, and is not limited thereto.

The sensor data 210 according to an embodiment may include various data that are recognized as LiDAR data other than the examples described above.

The sensor data 210 according to an embodiment may include at least one piece of frame data.

Frame data according to an embodiment may mean a plurality of point data groups that is considered as being obtained at one time point. For example, the frame data may be a group of point data obtained for one cycle for which point data corresponding to all of 2D position coordinates are obtained. The frame data is not limited thereto and may be a group of point data obtained for a time interval shorter than one cycle.

The frame data according to an embodiment may mean a plurality of point data groups representing one scene. For example, the frame data may be a group of point data corresponding to all of available 2D position coordinates. The frame data is not limited thereto and may be a group of point data corresponding to some available 2D position coordinates.

The sensor data 210 according to an embodiment is not limited thereto and may include various data that are generally understood as frame data other than the examples described above.

The sensor data 210 according to an embodiment may include at least one piece of attribute data.

The attribute data according to an embodiment may mean data relating to the property of a sub-point dataset such as class information, center position information, size information, shape information, identification information, etc. for a sub-point dataset included in at least one piece of frame data according to an embodiment.

The attribute data according to an embodiment may mean data relating to the property of a plurality of sub-point datasets considered as representing a same object in a plurality of frame data such as movement information, identification information, and trajectory information for a plurality of sub-point datasets included in a plurality of frame data according to an embodiment.

The sensor data 210 according to an embodiment is not limited thereto and may include various data that are generally understood as attribute data other than the examples described above.

Meanwhile, a configuration referred to as frame data may be configured as attribute data as well herein unless frame data and attribute data are specifically distinguished.

The sensor data 210 according to an embodiment may include continuous frame data over time.

The continuous frame data over time according to an embodiment may mean frame data obtained in order of time.

The sensor 210 according to an embodiment can generate frame data in accordance with a preset frame rate. For example, the sensor 200 can generate 10 to 30 frame data for 1 second and is not limited thereto.

The frame data according to an embodiment may include corresponding time point information. In this case, the meaning that the frame data according to an embodiment includes corresponding time point information may mean that specific time point information is matched to the frame data according to an embodiment, but is not limited thereto.

For example, the frame data according to an embodiment may include time point information corresponding to the time point when the frame data starts to be generated. For example, the frame data according to an embodiment may include time point information corresponding to the time point when generation of the frame data is finished. For example, the frame data according to an embodiment may include time point information corresponding to the time point when the frame data starts to be generated and/or a representative time point obtained on the basis of the time point when generation is finished. For example, the frame data according to an embodiment may include time point information corresponding to a time point when point data included in the frame data has been obtained over a critical value, and is not limited thereto.

The sensor data 210 according to an embodiment may include continuous attribute data over time.

The attribute data according to an embodiment may include corresponding time point information. In this case, the meaning that the attribute data according to an embodiment includes corresponding time point information may mean that specific time point information is matched to the attribute data according to an embodiment, but is not limited thereto.

Time point information corresponding to the attribute data according to an embodiment may be the same as the time point information corresponding to the frame data used to generate the attribute data, and is not limited thereto.

When the attribute data according to an embodiment is obtained using a plurality of frame data, time point information corresponding to the attribute data may be at least one of a start time point, an end time point, or a middle time point of time points corresponding to the plurality of frame data, and is not limited thereto.

The sensor data 210 according to an embodiment may include installation position information of the sensor 200.

The installation position information according to an embodiment may include information about a user's living area where the sensor 200 is installed. For example, the installation position information may include information of a living room, a main bedroom, a kitchen, and/or a storage, etc.

The installation position information according to an embodiment may include information about adjacent home appliances. For example, the installation position information may include information of a TV section, a refrigerator section, and/or a washing machine section, etc.

The installation position information according to an embodiment may include information about home appliances disposed within a Field Of View (FOV) of the sensor 200. For example, the installation position information may include information of a TV sensing section, a refrigerator sensing section, and/or a washing machine sensing section, etc.

The installation position information according to an embodiment is not limited to the examples described above and may include various pieces of information that can specify the position where the sensor is installed.

The sensor data 210 according to an embodiment may include sensor identification information for the sensor 200.

The sensor identification information according to an embodiment may include information for distinguishing the sensor 200 from other sensors.

The sensor identification information according to an embodiment may include information about the hardware version of the sensor 200.

The sensor identification information according to an embodiment may include information about the firmware version of the sensor 200.

The sensor identification information according to an embodiment is not limited to the examples described above and may include information for specifying a corresponding sensor and/or information for representing the performance of a sensor, etc.

The sensor 200 according to an embodiment may be disposed in a living space of a user. For example, the sensor 200 may be installed such that the FOV at least partially overlaps an action space of a user. In this case, the user may be represented in frame data generated by the sensor 200.

The sensor 200 according to an embodiment may be installed such that the home appliance 300 is positioned in the FOV.

A plurality of sensors 200 according to an embodiment may be disposed. For example, the plurality of sensors may be installed such that their FOVs overlap each other. For example, the plurality of sensors may be installed such that their FOVs do not overlap each other. For example, the plurality of sensors may be installed such that the FOVs of only some sensors of the plurality of sensors overlap each other.

When the sensor 200 includes a LiDAR device in accordance with an embodiment, it may be possible to generate one piece of frame data by matching frame data generated by the sensors. For example, at least one sensor of the plurality of sensors determines global coordinates of frame data in consideration of the installation positions and angles of the plurality of sensors, converts the coordinates of the frame data into coordinates in a global coordinate system, and matches the frame data converted into the global coordinates, thereby being able to generate one piece of frame data in the global coordinate system. To this end, the plurality of sensors may need to be synchronized with each other, may need to have smooth communication therebetween, and may require computing power of a predetermined level.

The sensor 200 according to an embodiment may include a sensing module, a memory, a communication module, and/or a processor.

The sensing module according to an embodiment may be provided to output at least one light beam or sense at least one light beam.

The sensing module according to an embodiment may include a laser output unit for outputting at least one light beam and/or a detecting unit for sensing at least one light beam, but is not limited thereto.

The processor according to an embodiment may be provided to generate at least one sensor data on the basis of at least one signal obtained from the sensing module.

The processor according to an embodiment can generate at least one piece of point data on the basis of at least one signal obtained from the sensing module.

The processor according to an embodiment can generate at least one piece of frame data on the basis of at least one signal obtained from the sensing module.

The processor according to an embodiment can generate at least one piece of attribute data on the basis of at least one signal obtained from the sensing module.

The processor according to an embodiment is not limited thereto and can generate various kinds of data that are generally understood as sensor data other than the examples described above.

The processor according to an embodiment may be provided to process at least one piece of generated sensor data.

The processor according to an embodiment can obtain at least one piece of frame data by processing at least one piece of point data.

The processor according to an embodiment can obtain at least one piece of attribute data by processing at least one piece of point data.

The processor according to an embodiment can obtain at least one piece of attribute data by processing at least one piece of frame data and is not limited thereto.

The memory according to an embodiment can store sensor data according to an embodiment.

The memory according to an embodiment can store data generated by the processor according to an embodiment.

The memory according to an embodiment can store data processed by the processor according to an embodiment, and is not limited thereto.

Since matters relating to the point data, the frame data, and the attribute data were described above, repeated description is omitted.

The processor according to an embodiment can perform data communication with an external device in a wired and/or wireless type using the communication module. For example, the processor can perform bidirectional or unidirectional communication with an external device using the communication module and is not limited thereto.

Meanwhile, the processor may be configured as a Central Processing Unit (CPU), a Graphics Processing Unit (GPU), a Digital Signal Processor (DSP), a state machine, an Application Specific Integrated Circuit (ASIC), a Radio-Frequency Integrated Circuit (RFIC), and a combination thereof, and is not limited thereto.

The sensor 200 according to an embodiment may be provided as other sensors than the LiDAR device described above.

The sensor 200 according to an embodiment may include a depth camera, an RGB camera, a black and white camera, and/or an IR camera, etc. The sensor 200 according to an embodiment of the present disclosure is not limited thereto and may include various kinds of sensors.

Even though the sensor 200 according to an embodiment is provided as another sensor other than the LiDAR device described above, the matters described above in relation to the sensor data can be applied.

When the sensor 200 according to an embodiment includes a depth camera, the sensor data according to an embodiment may include a depth image including at least one piece of point data. In this case, the at least one piece of point data may include 2D position coordinates (X, Y) and a depth value d, but is not limited thereto.

When the sensor 200 according to an embodiment includes an RGB camera, the sensor data according to an embodiment may include an RGB image including at least one piece of point data. In this case, the at least one piece of point data may include 2D position coordinates (X, Y) and color values R, G, and B, but is not limited thereto.

When the sensor 200 according to an embodiment includes a black and white camera, the sensor data according to an embodiment may include a black and white image including at least one piece of point data. In this case, the at least one piece of point data may include 2D position coordinates (X, Y) and a brightness value V, but is not limited thereto.

When the sensor 200 according to an embodiment includes an IR camera, the sensor data according to an embodiment may include an IR image including at least one piece of point data. In this case, the at least one piece of point data may include 2D position coordinates (X, Y) and a radiant heat value, but is not limited thereto.

Even through the sensor 200 according to an embodiment is provided as another sensor other than the LiDAR device described above, the matters described above in relation to the frame data and the attribute data can be applied.

The home appliance 300 according to an embodiment may mean various kinds of electrical appliances that are used in daily life by a user. For example, the home appliance 300 may include a TV, a projector, a set-top box, a speaker, a lighting device, a refrigerator, a rice pot, a dish washer, a microwave, an oven, an electric pot, a coffee machine, an air conditioner, a humidifier, a dehumidifier, a heater, a fan, a circulator, a washing machine, a cleaner, an air purifier, a drier, a clothing care system, a massager, an electric curtain rail, etc., and is not limited thereto.

The home appliance 300 according to an embodiment may include various life assistant devices.

The home appliance 300 according to an embodiment may include devices that interact with pets. For example, home appliance 300 may include a feeding device, a water supply device, a play device, a waste disposal device, etc., but is not limited thereto.

The home appliance 300 according to an embodiment can operate on the basis of operation control instructions from a user. For example, the home appliance 300 can start to operate in accordance with a turning-on instruction from a user and can stop operating in accordance with a turning-off instruction from a user. For example, when the home appliance 300 includes a TV, the home appliance 300 can turn on the screen in accordance with screen turning-on instruction from a user and can change set channels in accordance with a channel change instruction, and is not limited thereto.

The home appliance 300 according to an embodiment can directly and/or indirectly receive control instructions from a user. The home appliance 300 is not limited thereto and may receive control instructions from a user through a communication device.

The home appliance 300 according to an embodiment may be disposed in a living space of a user. Accordingly, the home appliance 300 can interact with the user. When the home appliance 300 according to an embodiment can be divided into a plurality of parts, some of the parts may be disposed in a living space of a user and the others may be disposed outside the living space of the user. For example, an air conditioner may be disposed in a living space of a user and the outdoor unit may be disposed outside the living space of the user.

The home appliance 300 according to an embodiment may be positioned in the FOV of the sensor 200. In this case, the home appliance 300 may be represented in frame data generated by the sensor 200.

The home appliance 300 according to an embodiment may generate home appliance data 310.

The home appliance data 310 according to an embodiment may include information relating to the state and the operation of a home appliance.

The home appliance data 310 according to an embodiment may include home appliance identification information for the home appliance 300.

The home appliance identification information according to an embodiment may include information for distinguishing the home appliance 300 from other home appliances 300. For example, the home appliance identification information may include information about the kinds of home appliances such as a TV, a refrigerator, a washing machine, etc. For example, the home appliance identification information may include information for distinguishing home appliances of the same kind such as a first TV, a second TV, etc.

The home appliance identification information according to an embodiment may include information about the hardware version and/or the firmware version of the home appliance 300.

The home appliance data 310 according to an embodiment may include operation time point information relating to an operation of a home appliance.

The operation time point information according to an embodiment may be information relating to the time point when the home appliance 300 operated by interacting with a user. For example, the operation time point information may be a time point when the home appliance 300 started to interact with a user. For example, the operation time point information may be a time point when the home appliance was warmed up by interacting with a user. For example, the operation time point information may be a time point when the home appliance 300 started to actually operate by interacting with a user. For example, the operation time point information may be a time point when the home appliance 300 actually stopped operating by interacting with a user. For example, the operation time point information may be a time point when the home appliance 300 finished interacting with a user. For example, the operation time point information may be a time period for which the home appliance 300 interacted with a user, and is not limited thereto.

The home appliance data 310 according to an embodiment may include operation type information relating to an operation of a home appliance.

The operation type information according to an embodiment may be information relating to the detailed matters of operation performed by the home appliance 300 by interacting with a user. For example, the operation type information may be turning-on information of the home appliance 300 through interaction with a user. For example, the operation type information may be turned-off information of the home appliance 300 through interaction with a user. For example, the operation type information may be warming-up information of the home appliance 300 through interaction with a user. The operation type information is not limited thereto and may be information about detailed operations performed by the home appliance 300 by interacting with a user. The information about detailed operations may reflect various operation types, depending on the purpose of the home appliance 300.

The home appliance data 310 according to an embodiment may include installation position information of a home appliance. The installation position information according to an embodiment may include information about a user's living area where the home appliance 300 is installed. For example, the installation position information may include information of a living room, a main bedroom, a kitchen, and/or a storage, etc.

The home appliance 300 according to an embodiment can transmit the home appliance data 310 to the outside. For example, the home appliance 300 can transmit the home appliance data 310 to another home appliance, a server device, a sensor, etc., and is not limited thereto.

A plurality of home appliances 300 according to an embodiment may be disposed. For example, a plurality of home appliances 300 may be disposed in a same living space of a user. For example, some of a plurality of home appliances 300 may be disposed in a first living space and the others may be disposed in a second living space.

Hereafter, modules included in the motion prediction system 100 are described in detail.

Referring to FIG. 1 again, the motion prediction system 100 according to an embodiment may include a data transmission/reception module 110, a training data generation module 120, a motion prediction model training module 130, a motion prediction module 140, and/or a training data management module 150.

The data transmission/reception module 110 according to an embodiment may be configured as a wired communication module. For example, the data transmission/reception module 110 may be configured as an Ethernet module, a serial communication module, a Universal Serial Bus (USB) communication module, a Power Line Communication (PLC) module, a Controller Area Network (CAN) module, and/or an RS-485 module, and is not limited thereto.

The data transmission/reception module 110 according to an embodiment may be configured as a wireless communication module. For example, the data transmission/reception module 110 may be configured as a Wi-Fi module, a Bluetooth module, a Zigbee module, a Long-Term Evolution (LTE) module, a Narrowband Internet of Things (NB-IoT) module, and/or a Long range (LoRa) module, and is not limited thereto.

The data transmission/reception module 110 according to an embodiment can receive sensor data 210 from the sensor 200. Since the matters described above can be applied to the sensor data 210 according to an embodiment, repeated description is omitted.

The data transmission/reception module 110 according to an embodiment can receive various kinds of data such as information for generating training data to be described below, information for managing the generated training data, and/or information for driving a trained motion prediction model to be described below, etc. from the sensor 200.

The data transmission/reception module 110 according to an embodiment can transmit sensor data request information to be described below to the sensor 200. Accordingly, the data transmission/reception module 110 can receive sensor data 210 from the sensor 200, and is not limited thereto.

The data transmission/reception module 110 according to an embodiment can receive the home appliance data 310 from the home appliance 300. Since the matters described above can be applied to the home appliance data 310 according to an embodiment, repeated description is omitted.

The data transmission/reception module 110 according to an embodiment can transmit operation control information 320 to be described below to the home appliance 300.

The operation control information 320 according to an embodiment may include information about an operation type that the home appliance 300 is supposed to perform. For example, the operation control information 320 may include information for a turning-on operation of a home appliance. For example, the operation control information 320 may include information for a turning-off operation of a home appliance. For example, the operation control information 320 may include information for a warming-up operation of a home appliance. The operation control information 320 is not limited thereto and may include information for each of detailed operation types of the home appliance 300.

The data transmission/reception module 110 according to an embodiment can receive information relating to a time point set in the sensor 200 from the sensor 200. The data transmission/reception module 110 according to an embodiment can receive information relating to a time point set in the home appliance 300 from the home appliance 300.

The data transmission/reception module 110 according to an embodiment can transmit information relating to time point adjustment to the sensor 200 and/or the home appliance 300 by comparing the time point set in the sensor 200 and the time point set in the home appliance 300. For example, when the time point set in the sensor 200 is earlier than the time point set in the home appliance 300, the data transmission/reception module 110 can transmit information for delaying a time point to the sensor 200. For example, when the time point set in the sensor 200 is earlier than the time point set in the home appliance 300, the data transmission/reception module 110 can transmit information for advancing a time point to the home appliance 300. Accordingly, the data transmission/reception module 110 can synchronize information relating to a time point included in the sensor data 210 and information relating to a time point included in the home appliance data 310.

The data transmission/reception module 110 is not limited thereto and can generate and provide information relating to the degree of difference between the time point set in the sensor 200 and the time point set in the home appliance 300 to the training data generation module to be described below.

The motion prediction model according to an embodiment of the present disclosure may mean a model used to predict whether a home appliance will be operated. For example, the motion prediction model may be a model that predicts whether a home appliance will be operated by receiving sensor data. For example, the motion prediction model may be a model that predicts whether a TV will perform a turning-on operation by receiving LiDAR data, and is not limited thereto.

The motion prediction model according to an embodiment may be configured as an AI model. For example, the motion prediction model may include at least one designed AI model, and is not limited thereto.

The designed AI model according to an embodiment may include at least one Artificial Neural Network (ANN) layer. For example, the designed AI model may include at least one artificial neural network layer of various artificial neural network layers such as a feedforward neural network, a radial basis function network or a Kohonen self-organizing network, a Deep Neural Network (DNN), a Convolutional Neural Network (CNN), a Recurrent Neural Network (RNN), a Long Short Term Memory (LSTM) network, or Gated Recurrent Units (GRU).

At least one artificial neural network layer included in the designed AI model according to an embodiment can use same or different activation functions. An activation function according to an embodiment may include a Sigmoid Function, a Tanh Function, a Rectified Linear unit Function (Relu Function), a leaky Relu Function, an Exponential Linear unit (ELU) function, a Softmax function, etc., and is not limited thereto. The activation function according to an embodiment may include various activation functions (including custom activation functions) for outputting a result value or transmitting a result value to other artificial neural network layers.

The motion prediction model training module 130 according to an embodiment to be described below can use at least one loss function to train the designed AI model. The loss function according to an embodiment may include a Mean Squared Error (MSE), a Root Mean Squared Error (RMSE), Binary Crossentropy, Categorical Crossentropy, Sparse Categorical Crossentropy, etc., and is not limited thereto. The loss function according to an embodiment may include various functions (including custom loss functions) for calculating the difference between a predicted result value and an actual result value.

The motion prediction model training module 130 according to an embodiment can use at least one optimizer to train the designed AI model. The optimizer according to an embodiment can be used to update a relationship parameter between an input value and a result value. The optimizer according to an embodiment may include Gradient descent, Batch Gradient Descent, Stochastic Gradient Descent, Mini-batch Gradient Descent, Momentum, AdaGrad, RMSProp, AdaDelta, Adam, NAG, NAdam, RAdam, AdamW, etc., and is not limited thereto.

The motion prediction model according to an embodiment may be configured as a model for predicting whether one operation type is performed for one home appliance. For example, the motion prediction model may be configured as a model for predicting a turning-on operation of a TV. For example, the motion prediction model may be configured as a model for predicting a turning-off operation of a TV, and is not limited thereto.

The motion prediction model according to an embodiment may be configured as a model for predicting whether a plurality of operation types is performed for one home appliance. For example, the motion prediction model may be configured as a model for predicting a turning-on operation and a turning-off operation of a TV. For example, the motion prediction model may be configured as a model for predicting a turning-on operation and a turning-off operation of a projector, and is not limited thereto.

The motion prediction model according to an embodiment may be configured as a model for predicting at least one operation corresponding to each of a plurality of home appliances. For example, the motion prediction model may be configured as a model for predicting a turning-on operation of a TV and a turning-on operation of a projector. For example, the motion prediction model may be configured as a model for predicting a turning-on operation and a turning-off operation of a TV and a turning-on operation and a turning-off operation of a projector, and is not limited thereto.

The training data generation module 120 according to an embodiment may mean a module for generating training data that is used to train the home appliance motion prediction model described above, and may include physical and functional configurations.

The training data generation module 120 according to an embodiment can generate training input data on the basis of obtained sensor data 210. For example, the training data generation module 120 can generate training input data on the basis of a plurality of obtained frame data, but is not limited thereto.

The training data generation module 120 according to an embodiment can select at least some sensor data from obtained sensor data 210 to generate training input data. For example, the training data generation module 120 can select at least some frame data from a plurality of obtained frame data, but is not limited thereto.

The training data generation module 120 according to an embodiment can select at least some sensor data from sensor data 210 on the basis of obtained home appliance data 310. For example, the training data generation module 120 can select at least some frame data from a plurality of frame data on the basis of obtained home appliance data 310, but is not limited thereto.

The training data generation module 120 according to an embodiment can select at least some frame data from a plurality of frame data on the basis of operation time point information included in obtained home appliance data 310, but is not limited thereto.

The training data generation module 120 according to an embodiment can select at least some frame data from a plurality of frame data on the basis of operation time point information included in obtained home appliance data 310 and time point information matched to the plurality of frame data, but is not limited thereto.

Selection of sensor data according to an embodiment is described below.

The training data generation module 120 according to an embodiment can generate information for requesting sensor data on the basis of obtained home appliance data 310 to generate training input data.

The training data generation module 120 according to an embodiment can generate sensor data request information including operation time point information included in obtained home appliance data 310, but is not limited thereto.

The training data generation module 120 according to an embodiment can generate sensor data request information including reference time point information on the basis of operation time point information included in obtained home appliance data 310, but is not limited thereto.

The training data generation module 120 according to an embodiment can generate sensor data request information including reference time point information determined on the basis of the time point when home appliance data 310 was obtained, but is not limited thereto.

The training data generation module 120 according to an embodiment can generate training input data by performing pre-processing on sensor data 210. The pre-processing according to an embodiment can be understood as a concept including generation of training input data based on sensor data 210. For example, pre-processing may include various concepts that are generally understood as pre-processing such as an operation of converting the format of data that is input to a motion prediction model and/or an operation for removing noise of data, etc. The details of pre-processing are described below.

The training data generation module 120 according to an embodiment can determine training output data.

The training output data according to an embodiment can be represented as labeling data, a label value, annotation data, and/or annotation value, etc., and may mean result data corresponding to training input data that is used for machine learning or used to train an AI model. The training output data according to an embodiment is not limited thereto and may include concepts such as training output data, labeling data, a label value, annotation data, and/or an annotation value, etc. that are generally understood.

The training data generation module 120 according to an embodiment can generate training data by allocating determined training output data to generated training input data. For example, the training data generation module 120 can generate training data by allocating a label value to generated training input data. For example, the training data generation module 120 can generate training data by allocating a first value to training input data. For example, the training data generation module 120 can generate training data by allocating a label value corresponding to TV turning-on to training input data, and is not limited thereto.

The training data generation module 120 according to an embodiment can determine a label value on the basis of home appliance data 310.

The training data generation module 120 according to an embodiment can determine a label value on the basis of operation type information included in home appliance data 310. For example, the home appliance data 310 can determine a corresponding label value on the basis of TV turning-on information included in home appliance data 310, and is not limited thereto.

The training data generation module 120 according to an embodiment can determine a label value on the basis of home appliance identification information included in home appliance data 310. For example, the home appliance data 310 can determine a corresponding label value on the basis of first TV turning-on information included in home appliance data 310, an is not limited thereto.

The training data generation module 120 according to an embodiment can determine a label value on the basis of installation position information included in home appliance data 310. For example, the home appliance data 310 can determine a corresponding label value on the basis of living room TV turning-on information included in home appliance data 310, and is not limited thereto.

The training data generation module 120 according to an embodiment can generate training data by allocating a label value, which corresponds to non-action of a home appliance, to training input data. For example, the training data generation module 120 can generate training data by allocating a label value, which corresponds to non-action of a home appliance, to training input data generated on the basis of sensor data obtained when the home appliance is not operated. For example, the training data generation module 120 can generate training data by allocating a label value, which corresponds to non-action of a TV, to training input data generated on the basis of sensor data obtained when the TV is not operated, and is not limited thereto.

The training data generation module 120 according to an embodiment can generate training dataset on the basis of at least one piece of generated training data. The training data according to an embodiment may mean one training input data and one piece of training output data allocated thereto. The training dataset according to an embodiment may mean a dataset including a plurality of training data, and is not limited thereto.

The training data generation module 120 according to an embodiment can generate training data having a same label value as one training dataset. The training data generation module 120 according to an embodiment can generate training data for a same home appliance as one training dataset. The training data generation module 120 is not limited thereto and can distinguish generated training data into at least one training dataset.

Training datasets according to an embodiment can be distinguished from each other. For example, training datasets can be distinguished from each other on the basis of stored addresses. For example, training datasets can be distinguished from each other on the basis of allocated tags. For example, training datasets can be distinguished from each other on the basis of generation time points, and are not limited thereto.

One training dataset according to an embodiment can be used to train one motion prediction model. The present disclosure is not limited thereto and one motion prediction model may be trained using a plurality of training data sets.

The motion prediction model training module 130 according to an embodiment can train a motion prediction model that is used to predict an operation of the home appliance 300 using training data. For example, the motion prediction model training module 130 can train a motion prediction model that is used to predict an operation of the home appliance 300 using training data generated by the training data generation module 120. For example, the motion prediction model training module 130 can train a motion prediction model that is used to predict an operation of the home appliance 300 using a dataset, and is not limited thereto.

The motion prediction model training module 130 according to an embodiment can train a motion prediction model for predicting whether one operation type is performed for one home appliance.

The motion prediction model training module 130 according to an embodiment can select training data on the basis of the kind and/or the operation type of a home appliance of which an operation is predicted, in order to train a motion prediction model for predicting whether one operation type is performed for one home appliance. For example, the motion prediction model training module 130 can select training data allocated with a label value corresponding to TV turning-on to train a model that predicts a turning-on operation of a TV. For example, the motion prediction model training module 130 can select training data allocated with a label value corresponding to TV turning-on and training data allocated with a label value corresponding to TV non-action in order to train a model that predicts a turning-on operation of a TV, and is not limited thereto.

The motion prediction model training module 130 according to an embodiment can train a motion prediction model for predicting whether a plurality of operation types is performed for one home appliance.

The motion prediction model training module 130 according to an embodiment can select training data on the basis of the kind and/or the operation type of a home appliance of which an operation is predicted, in order to train a motion prediction model for predicting whether a plurality of operation types is performed for one home appliance. For example, the motion prediction model training module 130 can select training data allocated with a label value corresponding to a TV to train a model that predicts an operation of a TV. For example, the motion prediction model training module 130 can select training data allocated with a label value corresponding to TV turning-on and training data allocated with a label value corresponding to TV turning-off to train a model that predicts a turning-on operation and a turning-off operation of a TV. For example, the motion prediction model training module 130 can select training data allocated with a label value corresponding to TV turning-on, training data allocated with a label value corresponding to TV turning-off, and training data allocated with a label value corresponding to TV non-action to train a model that predicts a turning-on operation and a turning-off operation of a TV.

The motion prediction model training module 130 according to an embodiment can train a motion prediction model for predicting at least one operation corresponding to each of a plurality of home appliances.

The motion prediction model training module 130 according to an embodiment can select training data on the basis of the kind and/or the operation type of a home appliance of which an operation is predicted, in order to train a motion prediction model for predicting whether at least one operation type is performed for each of a plurality of home appliances. For example, the motion prediction model training module 130 can select training data allocated with a label value corresponding to a TV and training data allocated with a label value corresponding to a projector to train a model that predicts an operation of a TV and a projector. For example, the motion prediction model training module 130 can select training data allocated with a label value corresponding to TV turning-on, training data allocated with a label value corresponding to TV turning-off, training data allocated with a label value corresponding to TV non-action, training data allocated with a label value corresponding to projector turning-on, training data allocated with a label value corresponding to projector turning-off, and training data allocated with a label value corresponding to projector non-action in order to train a model that predicts operations of TV turning-on, TV turn-of, projector turning-on, and projector turning-off, and is not limited thereto.

The motion prediction model training module 130 according to an embodiment can train a motion prediction model for each user by distinguishing users.

The motion prediction model training module 130 according to an embodiment can select training data on the basis of users to train motion prediction models for respective users. For example, the motion prediction model training module 130 can select training data relating to a person A to train a motion prediction model by the person A. For example, the motion prediction model training module 130 can select training data relating to a person A from training data allocated with a label value corresponding to TV turning-on to train a motion prediction model that predicts a TV turning-on operation by the person A.

The motion prediction module 140 according to an embodiment can obtain motion prediction information for the home appliance 300 using a trained motion prediction model. For example, the motion prediction module 140 according to an embodiment can obtain motion prediction information for the home appliance 300 using a motion prediction model trained by the motion prediction model training module 130. For example, the motion prediction module 140 according to an embodiment can obtain motion prediction information for the home appliance 300 by applying obtained sensor data to a motion prediction model trained by the motion prediction model training module 130. For example, the motion prediction module 140 according to an embodiment can obtain motion prediction information for the home appliance 300 by applying prediction input data generated on the basis of obtained sensor data to a motion prediction model trained by the motion prediction model training module 130.

The motion prediction module 140 according to an embodiment can obtain sensor data 210. For example, the motion prediction module 140 can obtain sensor data 210 through the data transmission/reception module 110.

The motion prediction module 140 according to an embodiment can generate prediction input data on the basis of obtained sensor data 210. For example, the motion prediction module 140 can generate prediction input data on the basis of a plurality of obtained frame data, but is not limited thereto.

The motion prediction module 140 according to an embodiment can select at least some sensor data from obtained sensor data 210 to generate prediction input data. For example, the motion prediction module 140 can select at least some frame data from a plurality of obtained frame data, and is not limited thereto.

Since the matters about generation of training input data from sensor data 210 by the training data generation module 120 according to an embodiment described above can be applied so that the motion prediction module 140 generates prediction input data from sensor data 210, repeated description is omitted.

Motion prediction information obtained by the motion prediction module 140 according to an embodiment can include the result of predicting whether the home appliance 300 is operated. For example, the motion prediction information may include a probability value predicting whether the home appliance 300 is operated. For example, the motion prediction information may include a value showing which operation of a plurality of operation type is predicted. For example, the motion prediction information may include a value showing an operation of what home appliance 300 is predicted. For example, the motion prediction information may include a value showing what operation of what home appliance 300 is predicted, and is not limited thereto.

The motion prediction module 140 according to an embodiment can generate operation control information 320 on the basis of obtained motion prediction information. For example, when a probability value predicting whether an operation included in motion prediction information is performed is over a critical value, the motion prediction module 140 can generate operation control information 320 for making the home appliance 300 perform the operation. For example, the motion prediction module 140 can generate operation control information 320 for making the home appliance 300 perform a corresponding operation on the basis of an operation type included in motion prediction information. For example, the motion prediction module 140 can generate operation control information 320 for making a home appliance perform a corresponding operation on the basis of an operation type included in motion prediction information and it is an operation of what home appliance, and is not limited thereto.

The motion prediction module 140 according to an embodiment can generate operation control information 320 for making the home appliance 300 perform an operation on the basis of obtained motion prediction information and a user's response. For example, the motion prediction module 140 can provide a user with matters relating to motion prediction information and can receive a response from the user. In this case, the motion prediction module 140 may or may not create operation control information, depending on the user's response.

The motion prediction system 100 according to an embodiment can manage generated training data using the training data management module 150.

The training data management module 150 according to an embodiment can manage the versions of training data generated by the training data generation module 120.

The training data management module 150 according to an embodiment can manage the versions of training data on the basis of the generation time points of training data. For example, the training data management module 150 can manage the version of training data in accordance with where the generation time point of training data is included in a preset time period. For example, the training data management module 150 can manage training data generated in January and February in a pertinent year as a first version and can manage training data generated in March and April in the pertinent year as a second version, and is not limited thereto.

The training data management module 150 according to an embodiment can manage the versions of training data on the basis of the number of pieces of training data. For example, the data management module 150 can manage a preset number of training data as training data for one version. For example, the data management module 150 can manage training data generated from the first to the tenth as a first version and can manage training data generated from the eleventh to the twentieth as a second version, and is not limited thereto.

The motion prediction system 100 according to an embodiment can train a motion prediction model in accordance with the version of training data. For example, the motion prediction system 100 can train a first motion prediction model using training data of first version and can train a second motion prediction model using training data of second version, and is not limited thereto.

The data transmission/reception module 110, the training data generation module 120, the motion prediction model training module 130, the motion prediction module 140, and the training data management module 150 included in the motion prediction system 100 may be separated in terms of hardware and each may be configured as at least one processor.

The data transmission/reception module 110, the training data generation module 120, the motion prediction model training module 130, the motion prediction module 140, and the training data management module 150 included in the motion prediction system 100 may be separated in terms of function and may be entirely configured as one processor.

The present disclosure is not limited thereto, and at least some of the data transmission/reception module 110, the training data generation module 120, the motion prediction model training module 130, the motion prediction module 140, and the training data management module 150 may be separated in terms of hardware and two or more modules may be configured as at least one processor.

Meanwhile, a processor may be configured as a Central Processing Unit (CPU), a Graphics Processing Unit (GPU), a Digital Signal Processor (DSP), a state machine, an Application Specific Integrated Circuit (ASIC), a Radio-Frequency Integrated Circuit (RFIC), and a combination thereof, and is not limited thereto.

The motion prediction system 100 according to an embodiment may be configured as a server device. In this case, the server device can perform data communication with the sensor 200 and the home appliance 300, and can perform the operations of the modules described above.

The motion prediction system 100 according to an embodiment may be composed of a plurality of server devices. For example, the motion prediction system 100 may be composed of a local server device and a cloud server device.

The local server device according to an embodiment may include a server device disposed close to a living space of a user. Accordingly, the local server device can smoothly perform data communication with the sensor 200 and the home appliance 300, and delay of data transmission/reception between the sever device and the sensor 200 and/or the home appliance 300 can be minimized.

The cloud server device according to an embodiment may include a server device having high computing power. Accordingly, the cloud server device can smoothly generate training data and/or can smoothly train a motion prediction model. For example, the cloud server device may be a server device provided by the manufacturer of the home appliance 300 and/or the sensor 200.

The data transmission/reception module 110, the training data generation module 120, the motion prediction module 130, and/or the training data management module 150 included in the motion prediction system 100 according to an embodiment may be configured as processors included in the local server device. The training data generation module 120, the motion prediction model training module 130, and/or the training data management module 150 included in the motion prediction system 100 according to an embodiment may be configured as processors included in the cloud server device.

The motion prediction system 100 according to an embodiment may be configured as at least one processor included in the sensor 200. The motion prediction system 100 according to an embodiment may be configured as at least one processor included in the home appliance 300. At least some of a plurality of modules included in the motion prediction system 100 according to an embodiment may be configured as processors included in the sensor 200 and the others may be configured as processors included in the home appliance 300.

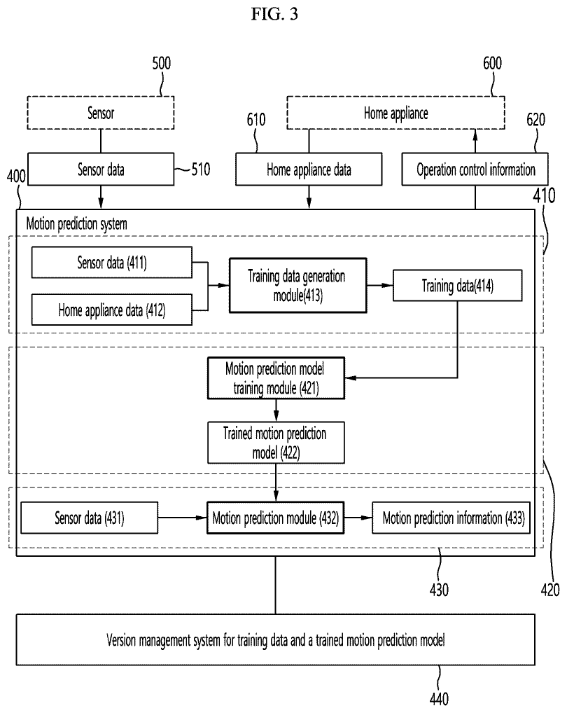

A motion prediction system according to an embodiment is described hereafter with reference to FIGS. 3 to 12.

FIG. 3 is a diagram illustrating a motion prediction system according to an embodiment.

Referring to FIG. 3, a motion prediction system 400 according to an embodiment may be a system for generating operation control information 620 for a home appliance 600 on the basis of sensor data 510 obtained from a sensor 500.

For example, the motion prediction system 400 according to an embodiment may be a system for generating turning-on information for a TV on the basis of LiDAR information obtained from a LiDAR device, but is not limited thereto.

In this configuration, since the matters described above can be applied to the sensor 500, the sensor data 510, the home appliance 600, and the operation control information 620, repeated description is omitted.

Referring to FIG. 3 again, the motion prediction system 400 according to an embodiment may be a system for training a motion prediction model on the basis of sensor data 510 obtained from the sensor 500 and home appliance data 610 obtained from the home appliance 600, and for generating operation control information 620 for the home appliance 600 using the trained motion prediction model.

For example, the motion prediction system 400 according to an embodiment may be a system for training a motion prediction model on the basis of LiDAR data obtained from a LiDAR device and TV turning-on information obtained from a TV, and for generating turning-on information for the TV using the trained motion prediction model, but is not limited thereto.

In this configuration, since the matters described above can be applied to the sensor 500, the sensor data 510, the home appliance 600, the home appliance data 610, and the operation control information 620, repeated description is omitted.

Referring to FIG. 3 again, the motion prediction system 400 according to an embodiment may include a training data generation system 410 for generating training data to train a motion prediction model on the basis of sensor data 510 obtained from the sensor 500 and home appliance data 610 obtained from the home appliance 600.

The training data generation system 410 according to an embodiment may be a system for generating training data 414 on the basis of sensor data 411 and home appliance data 412 and may be implemented by a training data generation module 413.

In this configuration, since the matters described above can be applied to the sensor data 411, the home appliance data 412, the training data 414, and the training data generation module 413, repeated description is omitted.

Further, in this configuration, the sensor data 411 may mean some of sensor data 510 obtained from the sensor 500, and may be separately described to specify some of the sensor data 510 that are used to generate training data 414 in the training data generation system 410 according to an embodiment, but is not limited thereto.

Further, in this configuration, the sensor data 412 may mean some of home appliance data 610 obtained from the home appliance 600, and may be separately described to specify some of the home appliance data 610 that are used to generate training data 414 in the training data generation system 410 according to an embodiment, but is not limited thereto.

According to the training data generation system 410 according to an embodiment, first training data can be generated on the basis of home appliance data 412 obtained at a first time point and sensor data 411 corresponding thereto, second training data can be generated on the basis of home appliance data 412 obtained at a second time point and sensor data 411 corresponding thereto, and a training dataset including a plurality of training data can be generated, but the specification may be described on the basis of one piece of training data for the convenience of description.

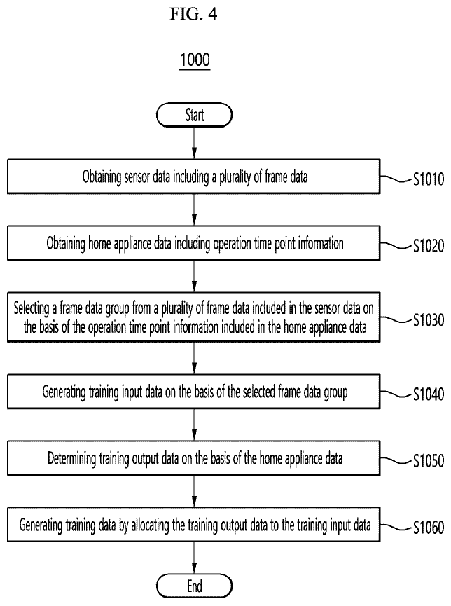

Hereafter, the training data generation system 410 is described in more detail with reference to FIGS. 4 to 6 and then the motion prediction system 400 is described again.

FIG. 4 is a diagram illustrating a method of generating training data according to an embodiment.

Referring to FIG. 4, a method 1000 of generating training data according to an embodiment may include at least one step of obtaining sensor data including a plurality of frame data (S1010), obtaining home appliance data including operation time point information (S1020), selecting a frame data group from a plurality of frame data included in the sensor data on the basis of the operation time point information included in the home appliance data (S1030), generating training input data on the basis of the selected frame data group (S1040), determining training output data on the basis of the home appliance data (S1050), and generating training data by allocating the training output data to the training input data (S1060), but is not limited thereto.

In the obtaining of sensor data including a plurality of frame data (S1010) according to an embodiment, the matters described above in relation to sensor data can be applied to the sensor data including a plurality of frame data, so repeated description is omitted.

Further, in the obtaining of home appliance data including operation time point information (S1020) according to an embodiment, the matters described above in relation to home appliance data can be applied to the home appliance data including operation time point information, so repeated description is omitted.

Further, in the selecting of a frame data group (S1030) according to an embodiment, the frame data group may include at least two frame data, but is not limited thereto.

Further, in the selecting of a frame data group according to an embodiment (S1030), the frame data group may be selected as a plurality of frame data obtained from a sensor before the operation time point of the operation time point information included in the home appliance data.

For example, in the selecting of a frame data group according to an embodiment (S1030), when the operation time point information included in the home appliance data includes a first time point, the frame data group may be selected as a plurality of frame data obtained from a sensor before the first time point, but is not limited thereto.

In this case, the plurality of frame data obtained from a sensor before the first time point may mean frame data matched with time point information corresponding to a time point before the first time point, but is not limited thereto.

Further, in the selecting of a frame data group according to an embodiment (S1030), the frame data group may be selected as a plurality of frame data obtained from a sensor for a specific time period before the operation time point of the operation time point information included in the home appliance data.

For example, in the selecting of a frame data group according to an embodiment (S1030), when the operation time point information included in the home appliance data includes a first time point, the frame data group may be selected as a plurality of frame data obtained from a sensor for a first time period before the first time point, but is not limited thereto.

In this case, the plurality of frame data obtained from a sensor for the first time period before the first time point may mean frame data matched with time point information corresponding to the first time period before the first time point, but is not limited thereto.

Further, the selecting of a frame data group according to an embodiment (S1030) may include selecting a frame data group that is used to generate training input data from a plurality of frame data on the basis of the operation time point information included in the home appliance data and a plurality of pieces of time point information matched to the plurality of frame data.

For example, the selecting of a frame data group according to an embodiment (S1030) may include selecting a frame data group that is used to generate training input data from a plurality of frame data by comparing the operation time point information included in the home appliance data and a plurality of pieces of time point information matched to the plurality of frame data, but is not limited thereto.

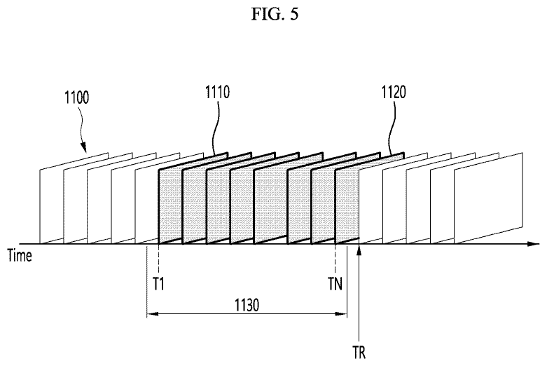

Further, the selecting of a frame data group according to an embodiment (S1030) will be described in more detail through FIG. 5.

Further, the generating of training input data according to an embodiment (S1040) may include selecting the selected frame data group as training input data.

For example, the generating of training input data according to an embodiment (S1040) may include selecting the selected frame data group itself as training input data, but is not limited thereto.

Further, the generating of training input data according to an embodiment (S1040) may include generating training input data by processing the selected frame data group.

In this case, the frame data group selected in the generating of training input data according to an embodiment (S1040) may be processed by various pre-processing algorithms.

A pre-processing algorithm according to an embodiment may include algorithms of various concepts that are generally understood as pre-processing.

The pre-processing algorithm according to an embodiment may include a point data processing algorithm that performs point data processing on point data included in frame data for each of frame data included in a frame data group.

The point data processing algorithm according to an embodiment may include an algorithm that segments at least some of points included in frame data for each of frame data included in a frame data group.

In more detail, the point data processing algorithm according to an embodiment may include an algorithm that segments at least one sub-point dataset of point data included in frame data for each of frame data included in a frame data group.

For example, the point data processing algorithm according to an embodiment may include an algorithm that segments at least one sub-point dataset on the basis of point data included in point cloud data, but is not limited thereto.

Further, as a more detailed example, the point data processing algorithm according to an embodiment may include an algorithm that segments a first sub-point dataset on the basis of point data included in point cloud data, but is not limited thereto.

Further, as a more detailed example, the point data processing algorithm according to an embodiment may include an algorithm that segments a first sub-point dataset corresponding to a first dynamic object on the basis of point data included in point cloud data, but is not limited thereto.

Further, as a more detailed example, the point data processing algorithm according to an embodiment may include an algorithm that segments a first sub-point dataset corresponding to a first dynamic object and a second sub-point dataset corresponding to a second dynamic object on the basis of point data included in point cloud data, but is not limited thereto.

Further, as a more detailed example, the point data processing algorithm according to an embodiment may include an algorithm that segments a first sub-point dataset corresponding to a first user and a second sub-point dataset corresponding to a second user on the basis of point data included in point cloud data, but is not limited thereto.

Further, as a more detailed example, the point data processing algorithm according to an embodiment may include an algorithm that segments a first sub-point dataset corresponding to a first user on the basis of the features of point data included in point cloud data and the feature of the first user and an algorithm that segments a second sub-point dataset corresponding to a second user on the basis of the features of point data included in point cloud data and the feature of the second user, but is not limited thereto.

In this case, at least some of the point data included in the first sub-point dataset and the point data included in the second sub-point dataset may be same point data, and are not limited thereto.

Meanwhile, the number of sub-point datasets that are segmented by the point data processing algorithm according to an embodiment is not limited to the examples described above, and the number of sub-point datasets may be determined on the basis of the number of dynamic objects represented in point cloud data.

Meanwhile, the number of sub-point datasets that are segmented by the point data processing algorithm according to an embodiment is not limited to the examples described above, and the number of sub-point datasets may be determined on the basis of the number of users represented in point cloud data.

The point data processing algorithm according to an embodiment may include an algorithm that removes the other point data excluding at least one sub-point dataset from point data included in frame data for each of frame data included in a frame data group, and is not limited thereto.

For example, the point data processing algorithm according to an embodiment may include an algorithm that removes the other point data except for at least one sub-point dataset on the basis of point data included in point cloud data, and is not limited thereto.

Further, as a more detailed example, the point data processing algorithm according to an embodiment may include an algorithm that removes the other point data except for a first sub-point dataset on the basis of point data included in point cloud data, and is not limited thereto.

Further, as a more detailed example, the point data processing algorithm according to an embodiment may include an algorithm that removes the other point data except for a first sub-point dataset corresponding to a first dynamic object on the basis of point data included in point cloud data, but is not limited thereto.

Further, as a more detailed example, the point data processing algorithm according to an embodiment may include an algorithm that removes point data except for a first sub-point dataset corresponding to a first dynamic object and a second sub-point dataset corresponding to a second dynamic object on the basis of point data included in point cloud data, but is not limited thereto.

Further, as a more detailed example, the point data processing algorithm according to an embodiment may include an algorithm that removes point data except for a first sub-point dataset corresponding to a first user and a second sub-point dataset corresponding to a second user on the basis of point data included in point cloud data, but is not limited thereto.

Further, as a more detailed example, the point data processing algorithm according to an embodiment may include an algorithm that removes point data except for a first sub-point dataset corresponding to a first user on the basis of the features of point data included in point cloud data and the feature of the first user and an algorithm that removes point data except for a second sub-point dataset corresponding to a second user on the basis of the features of point data included in point cloud data and the feature of the second user, but is not limited thereto.

In this case, at least some of the point data included in the first sub-point dataset and the point data included in the second sub-point dataset may be same point data, and are not limited thereto.

Meanwhile, the number of sub-point datasets that are considered in the point data processing algorithm according to an embodiment is not limited to the examples described above, and the number of sub-point datasets may be determined on the basis of the number of dynamic objects represented in point cloud data.

Meanwhile, the number of sub-point datasets that are considered in the point data processing algorithm according to an embodiment is not limited to the examples described above, and the number of sub-point datasets may be determined on the basis of the number of users represented in point cloud data.

The point data processing algorithm according to an embodiment may include an algorithm that obtains relative position data for each of point data included in frame data for frame data included in a frame data group.

The point data processing algorithm according to an embodiment may include an algorithm that changes the origin for position coordinates of point data included in frame data for each of frame data included in a frame data group.

For example, the point data processing algorithm according to an embodiment may include an algorithm that changes the origin for position coordinates of point data included in point cloud data, but is not limited thereto.

Further, as a more detailed example, the point data processing algorithm according to an embodiment may include an algorithm that changes the origin for position coordinates of point data included in point cloud data into a reference position, but is not limited thereto.

The reference position according to an embodiment may be set in advance.

Alternatively, the reference position according to an embodiment may be determined on the basis of the features of point data included in point cloud data.

For example, the reference position according to an embodiment may be the position of point data, in which a static object has been reflected, of point data included in point cloud data.

For example, the reference position according to an embodiment may be the position of point data, in which a home appliance has been reflected, of point data included in point cloud data.

For example, the reference position according to an embodiment may be the position of point data, in which a representative household has been reflected, of point data included in point cloud data, and is not limited thereto.

The point data processing algorithm according to an embodiment may include an algorithm that removes noise from point data included in frame data for each of frame data included in a frame data group.

For example, the point data processing algorithm according to an embodiment may include an algorithm that determines at least one piece of noise data of point data included in point algorithm data and removes noise from the noise data, but is not limited thereto.

For example, the point data processing algorithm according to an embodiment may include an algorithm that determines at least one piece of noise data of point data included in point algorithm data and removes the noise data, but is not limited thereto.

For example, the point data processing algorithm according to an embodiment may include an algorithm that determines at least one piece of noise data of point data included in point algorithm data and changes the value of the noise data, but is not limited thereto.

As a more detailed example, the point data processing algorithm according to an embodiment may include an algorithm that changes the value of noise data to a level close to the values of adjacent surrounding point data, but is not limited thereto.

As a more detailed example, the point data processing algorithm according to an embodiment may include an algorithm that changes the value of noise data to the average value of the values of adjacent surrounding point data, but is not limited thereto.

Noise data according to an embodiment may be point data corresponding to a very small area on point cloud data. For example, the noise data according to an embodiment may include one to three pieces of point data, and is not limited thereto.

The noise data according to an embodiment may be determined on the basis of at least one of the position coordinate value, the intensity value, the depth value, and the light capture value of point data, and is not limited thereto.

For example, in point data according to an embodiment, point data of which the 3D position coordinate value is different over a threshold value from 3D position coordinate values of adjacent surrounding point data may be determined as noise data, and is not limited thereto.

For example, in point data according to an embodiment, point data of which the intensity value is different over a threshold value from the intensity values of adjacent surrounding point data may be determined as noise data, and is not limited thereto.

For example, in point data according to an embodiment, point data of which the depth value is different over a threshold value from the depth values of adjacent surrounding point data may be determined as noise data, and is not limited thereto.

For example, in point data according to an embodiment, point data of which the light capture value is different over a threshold value from the light capture values of adjacent surrounding point data may be determined as noise data, and is not limited thereto.

The point data processing algorithm according to an embodiment may include an algorithm that smooths point data included in frame data for each of frame data included in a frame data group.

For example, the point data processing algorithm according to an embodiment may include an algorithm that smooths point data included in point cloud data.

In more detail, for example, the point data processing algorithm according to an embodiment may include an algorithm that smooths the values of point data included in point cloud data on the basis of the values of adjacent point data.

In more detail, for example, the point data processing algorithm according to an embodiment may include a smoothing algorithm for smoothing variation of the values of point data included in point cloud data and for reducing irregular fluctuation of the values on the basis of the values of adjacent point data.

The pre-processing algorithm according to an embodiment may include an algorithm that obtains attribute data from point data included in frame data for each of frame data included in a frame data group.

The pre-processing algorithm according to an embodiment may include an algorithm that obtains attribute data on the basis of the position coordinates of point data included in frame data for each of frame data included in a frame data group.

The pre-processing algorithm according to an embodiment may include an algorithm that processes the point data described above for each of frame data included in a frame data group and then obtains attribute data from point data included in the processed frame data.

The pre-processing algorithm according to an embodiment may include an algorithm that performs the point data processing described above on each of frame data included in a frame data group and then obtains attribute data on the basis of the position coordinates of point data included in the processed frame data.

In this case, the attribute data according to an embodiment may include at least one of center position information, object information, size information, shape information, volume information, magnitude information, and/or skeleton information of point data.

The pre-processing algorithm according to an embodiment may include an algorithm that obtains dynamic attribute data from frame data included in a frame data group.

The dynamic attribute data according to an embodiment may mean attribute data that can be obtained from at least two or more frame data and the term “dynamic attribute data” is used on the basis of the fact that the attribute data is obtained from frame data that continue in time series, but the dynamic attribute data is not limited thereto and may mean various kinds of attribute data that is obtained on the basis of a plurality of frame data.

The pre-processing algorithm according to an embodiment may include an algorithm that obtains attribute data for each of frame data included in a frame data group and then obtains dynamic attribute data on the basis of the obtained attribute data.

The pre-processing algorithm according to an embodiment may include an algorithm that performs the point data processing described above on each of frame data included in a frame data group and then obtains dynamic attribute data from the processed frame data.

In this case, the dynamic attribute data according to an embodiment may include at least one of trajectory information, movement information, speed information, and/or direction information for point data included in each of continuous frame data included in a frame data group.

In this case, the dynamic attribute data according to an embodiment may include at least one of trajectory information, movement information, speed information, and/or direction information for the attribute data of each of continuous frame data included in a frame data group.

The pre-processing algorithm according to an embodiment may include an algorithm that superposes frame data included in a frame data group.

The pre-processing algorithm according to an embodiment may include an algorithm that performs the point data processing described above on each of frame data included in a frame data group and then superposes the processed frame data.

In this case, superposing according to an embodiment may mean generating one piece of frame data by superposing frame data.

For example, the pre-processing algorithm according to an embodiment may include an algorithm that superposes point cloud data.

As a more detailed example, the pre-processing algorithm according to an embodiment may include an algorithm that generates one piece of cloud data by superposing point data included in first point cloud data that is first frame data and point data included in second point cloud data that is second frame data.

As a more detailed example, the pre-processing algorithm according to an embodiment may include an algorithm that generates one piece of cloud data representing all of point data included in first point cloud data and point data included in second point cloud data.

Accordingly, all of the values of point data included in each of point cloud data used for superposition can be represented in the point cloud data generated through superposition.

The pre-processing algorithm according to an embodiment is not limited thereto and may include an algorithm that generates one piece of cloud data representing at least some point data of point data included in first point cloud data and at least some point data of point data included in second point cloud data.

Accordingly, the values of at least some point data of point data included in each of point cloud data used for superposition can be represented in the point cloud data generated through superposition.

Meanwhile, the pre-processing algorithm according to an embodiment may include an algorithm that performs the point data processing described above on point cloud data and then superposes the processed point cloud data.

As a more detailed example, the pre-processing algorithm according to an embodiment may include an algorithm that generates one piece of cloud data by performing point data processing on first point cloud data that is first frame data, performing point data processing on point data included in the processed first point cloud data and on second point cloud data that is second frame data, and then superposing point data included in the processed second point cloud data.

As a more detailed example, the pre-processing algorithm according to an embodiment may include an algorithm that generates one piece of cloud data representing all of point data included in processed first point cloud data and point data included in processed second point cloud data.

Accordingly, all of the values of point data included in each of processed point cloud data used for superposition can be represented in the point cloud data generated through superposition.

The pre-processing algorithm according to an embodiment is not limited thereto and may include an algorithm that performs point data processing on first point cloud data, performs point data processing on at least some point data of point data included in the processed first point cloud data and on second point cloud data, and then generates one piece of cloud data representing at least some point data of point data included in the processed second point cloud data.

Accordingly, the values of at least some point data of point data included in each of processed point cloud data used for superposition can be represented in the point cloud data generated through superposition.

The present disclosure is not limited thereto and data superposition according to an embodiment may mean various data processing methods that are generally understood as data superposition.

The pre-processing algorithm according to an embodiment may include an algorithm that tags data to a frame data group.

Tagging according to an embodiment may mean a process of assigning a label or tag to data and tagging may be performed to help an AI model to be able to understand and use corresponding data in a process of training the AI model.

In more detail, the pre-processing algorithm according to an embodiment may include an algorithm that tags time information to a frame data group. The pre-processing algorithm according to an embodiment may include an algorithm that tags time information, which is determined on the basis of time information matched to each of frame data included in a frame data group, to the frame data group.

Time information according to an embodiment may be time information matched to the first frame data included in a frame data group. Alternatively, the time information may be time information matched to the last frame data included in a frame data group. Alternatively, the time information may be a median of time information matched to each of frame data included in a frame data group, and is not limited thereto.

Alternatively, the pre-processing algorithm according to an embodiment may include an algorithm that tags user information to a frame data group.

User information according to an embodiment may be information for distinguishing users. For example, user information may include various kinds of pieces of information that can specify users such as a user number, a user symbol, a user name, a user keyword, etc., and is not limited to the example described above.

The pre-processing algorithm according to an embodiment may include an algorithm that determines user information on the basis of the features of point data included in frame data and the features of users for each of frame data included in a frame data group, and tags the determined user information to the frame data group.

For example, the pre-processing algorithm according to an embodiment may include an algorithm determines user information on the basis of the features of point data included in point cloud data and the features of users and tags the determined user information to a frame data group.

User information according to an embodiment may be user information determined from the first frame data included in a frame data group. Alternatively, the user information may be user information determined from the last frame data included in a frame data group. Alternatively, the user information may be the most frequently determined user information of user information determined from each of frame data included in a frame data group, and is not limited thereto.

The generating of training input data (S1040) according to an embodiment may include generating training input data for each user by performing pre-processing of segmenting users represented in the selected frame data group. For example, the generating of training input data (S1040) according to an embodiment may include generating training input data for a first user by performing pre-processing of segmenting the first user represented in the selected frame data group. For example, the generating of training input data (S1040) according to an embodiment may include generating training input data for a second user by performing pre-processing of segmenting the second user represented in the selected frame data group, and is not limited thereto.

Further, the determining of training output data (S1050) according to an embodiment may include determining training output data on the basis of whether home appliance data is obtained.

For example, in the determining of training output data (S1050) according to an embodiment, when home appliance data corresponding to a TV operation is obtained, a first value corresponding to a TV operation can be determined as training output data, but the present disclosure is not limited thereto.

Further, the determining of training output data (S1050) according to an embodiment may include determining training output data on the basis of operation type information included in home appliance data.

For example, in the determining of training output data (S1050) according to an embodiment, when operation type information corresponding to TV ON is included in obtained home appliance data, a first value corresponding to TV ON can be determined as training output data, and when operation type information corresponding to TV OFF is included in obtained home appliance data, a second value corresponding to TV OFF can be determined as training output data, but the present disclosure is not limited thereto.

Further, since the matters described above can be applied to the determining of training output data (S1050) according to an embodiment, repeated description is omitted.

Further, in the generating of training data (S1060) according to an embodiment, the meaning of allocating training output data to training input data may be understood as a meaning of matching the training input data and the training output data and may be understood as a meaning of making a pair of training input data and training output data for training an AI or machine learning model, and is not limited thereto.

Further, since the matters described above can be applied to the generating of training data (S1060) according to an embodiment, repeated description is omitted.

FIG. 5 is a diagram illustrating in detail a method of selecting a frame data group according to an embodiment.

Referring to FIG. 5, a reference time point TR may be specified to select a frame data group that is used to generate training input data from a plurality of frame data 1100 in accordance with an embodiment.

In this case, the reference time point TR may be specified to correspond to an operation time point of a home appliance.

For example, the reference time point TR may be specified to correspond to operation time point information included in obtained home appliance data, but is not limited thereto.

Further, as an example, the reference time point TR may be specified to correspond to a time point obtained by home appliance data, but is not limited thereto.

Further, in this case, the reference time point TR may be specified on the basis of an operation time point of a home appliance.

For example, the reference time point TR may be calculated and specified on the basis of operation time point information included in obtained home appliance data. In more detail, the reference time point TR may be specified as a time point before a first preset time on the basis of operation time point information included in obtained home appliance data, but is not limited thereto.

Further, as an example, the reference time point TR may be calculated and specified on the basis of a time point obtained by home appliance data. In more detail, the reference time point TR may be specified as a time point before a first preset time on the basis of a time point obtained by home appliance data, but is not limited thereto.

Further, referring to FIG. 5, the frame data group that is used to generate training input data in accordance with an embodiment may be selected as a plurality of frame data obtained by a sensor earlier than the reference time point TR.

In this case, the time point when each of a plurality of frame data is obtained by a sensor may be determined by time point information matched to each of the plurality of frame data, but is not limited thereto.

For example, the frame data group that is used to generate training input data in accordance with an embodiment may be selected as first frame data 1110 obtained by a sensor at a first time point T1 earlier than the reference time point TR to an N-th frame data 1120 obtained by a sensor at an N-th time point TN, but is not limited thereto.

Further, referring to FIG. 5, a specific time period 1130 may be specified on the basis of the reference time point TR to select the frame data group that is used to generate training input data in accordance with an embodiment.

In this case, the specific time period 1130 may be 1 second to 10 seconds, but is not limited thereto.

For example, the specific time period 1130 may be specified as a time period between the reference time point TR and a time point before a first preset time interval from the reference time point TR, but is not limited thereto.

Further, as an example, the specific time period 1130 may be specified as a time period between a time point before a first preset time interval from the reference time point TR and a time point before a second preset time interval from the reference time point TR, but is not limited thereto.

Further, referring to FIG. 5, the frame data group that is used to generate training input data in accordance with an embodiment may be selected as a plurality of frame data obtained from a sensor within the specific time period 1130.

In this case, the time point when each of a plurality of frame data is obtained by a sensor may be determined by time point information matched to each of the plurality of frame data, but is not limited thereto.

For example, the frame data group that is used to generate training input data in accordance with an embodiment may be selected as first frame data 1110 and N-th frame data 1120 obtained by a sensor at a first time point T1 to an N-th time point TN included in the specific time period 1130, but is not limited thereto.

Further, referring to FIG. 5, a specific frame data may be specified on the basis of the reference time point TR to select the frame data group that is used to generate training input data in accordance with an embodiment.

For example, in order to select the frame data group that is used to generate training input data in accordance with an embodiment, N-th frame data 1120 obtained by a sensor at the N-th time point TN earlier than the reference time point TR may be specified as specific frame data, but is not limited thereto.

Further, referring to FIG. 5, the frame data group that is used to generate training input data in accordance with an embodiment may be selected on the basis of the specific frame data.

For example, the frame data group that is used to generate training input data in accordance with an embodiment may be selected to include first frame data 1110 that is frame data before one interval from the N-th frame data 1120 that is specific frame data, but is not limited thereto.

In this case, the one interval may be two or thirty, but is not limited thereto.

Further, the frame data group that is used to generate training input data in accordance with an embodiment may include frame data that continue in time series, but is not limited thereto.

For example, the frame data group that is used to generate training input data in accordance with an embodiment may include all of the first frame data 1110 to the N-th frame data 1120, but is not limited thereto and may include only some of the first frame data 1110 to the N-th frame data 1120.

For example, the frame data group that is used to generate training input data in accordance with an embodiment may be selected as odd-numbered data such as the first frame data 1110, third frame data, fifth frame data, etc. included in the first frame data 1110 to the N-th frame data 1120, but is not limited thereto.

Further, as an example, the frame data group that is used to generate training input data in accordance with an embodiment may be selected as even-numbered data such as second frame data, fourth frame data, sixth frame data, etc. included in the first frame data 1110 to the N-th frame data 4, but is not limited thereto.

Further, as an example, the frame data group that is used to generate training input data in accordance with an embodiment may be selected as some of frame data that continue in time series on the basis of a preset sampling rate, but is not limited thereto.

Further, the frame data group that is used to generate training input data in accordance with an embodiment may not include frame data obtained by a sensor within a second time interval from the operation time point of a home appliance.

To this end, the reference time point TR may be specified as a time point before the second time interval on the basis of operation time information included in obtained home appliance data in accordance with an embodiment, the reference time point TR may be specified as a time point before the second time interval on the basis of the time point when home appliance data was obtained in accordance with an embodiment, and when the reference time point TR is specified to correspond to the operation time point of a home appliance, the specific time period 1130 may be specified as a time period from the reference time point TR to a time point before the second time interval, and the specific frame data may be specified as frame data obtained before the second time interval from the reference time point TR.

This may be for making the selected frame data group not reflect movement of a user due to direct interaction of the user with a home appliance.

That is, the reason that the frame data group that is used to generate training input data in accordance with an embodiment is selected not to include frame data obtained by a sensor within the second time interval from the operation time point of a home appliance is for not putting frame data, which corresponds to a period for which a user performs a movement of holding a remote controller in hand and directing the remote controller to a TV to turn on the TV, into training input data.

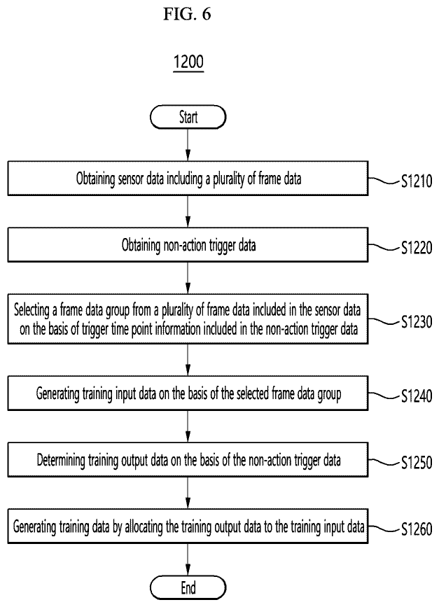

FIG. 6 is a diagram illustrating a method of generating training data according to an embodiment.

Referring to FIG. 6, a method 1200 of generating training data according to an embodiment may include at least one step of obtaining sensor data including a plurality of frame data (S1210), obtaining non-action trigger data (S1220), selecting a frame data group from a plurality of frame data included in the sensor data on the basis of trigger time point information included in the non-action trigger data (S1230), generating training input data on the basis of the selected frame data group (S1240), determining training output data on the basis of the non-action trigger data (S1250), and generating training data by allocating the training output data to the training input data (S1260), but is not limited thereto.

In this case, since the matters described above can be applied to the obtaining of sensor data including a plurality of frame data (S1210), the selecting of a frame data group from a plurality of frame data included in the sensor data on the basis of trigger time point information included in the non-action trigger data (S1230), the generating of training input data on the basis of the selected frame data group (S1240), the determining of training output data on the basis of the non-action trigger data (S1250), and the generating of training data by allocating the training output data to the training input data (S1260), repeated description is omitted.

Further, the method of generating training data that is described through FIG. 6 is a method of generating training data corresponding to non-action and may be applied with the method of generating training data described through FIG. 4.

In the obtaining of non-action trigger data (S1220) according to an embodiment, the non-action trigger data may mean trigger data for generating training input data for non-action.

Further, in the obtaining of non-action trigger data (S1220) according to an embodiment, the non-action trigger data may be obtained at every preset period.

For example, in the obtaining of non-action trigger data (S1220) according to an embodiment, the non-action trigger data may be obtained with a time interval of 1 hour, but is not limited thereto.

Further, in the obtaining of non-action trigger data (S1220) according to an embodiment, the non-action trigger data may be obtained on the basis of whether a dynamic object is recognized.

For example, in the obtaining of non-action trigger data (S1220) according to an embodiment, the non-action trigger data may be obtained when a dynamic object is recognized and home appliance data is not obtained, but is not limited thereto.

Further, for example, in the obtaining of non-action trigger data (S1220) according to an embodiment, the non-action trigger data may be obtained at a time point when a third time passes from the time point when a dynamic object is recognized, but is not limited thereto.

Further, for example, in the obtaining of non-action trigger data (S1220) according to an embodiment, the non-action trigger data may be obtained at a time point before 5 hours or more and/or after 4 hour or more from the time point when a dynamic object is recognized, but is not limited thereto.

Further, for example, in the obtaining of non-action trigger data (S1220) according to an embodiment, the non-action trigger data may be obtained when a dynamic object is recognized at a preset period, but is not limited thereto.

Further, in the obtaining of non-action trigger data (S1220) according to an embodiment, the non-action trigger data may be obtained at a certain time point.

Further, in the obtaining of non-action trigger data (S1220) according to an embodiment, the non-action trigger data may be obtained on the basis of whether home appliance data is obtained.

For example, in the obtaining of non-action trigger data (S1220) according to an embodiment, the non-action trigger data may not be obtained when home appliance data is obtained at a preset period, but is not limited thereto.

Further, for example, in the obtaining of non-action trigger data (S1220) according to an embodiment, when first home appliance data is obtained and second home appliance data is not obtained at a preset period, non-trigger data for a second home appliance may be obtained, but is not limited thereto.

Further, since the selecting of a frame data group from a plurality of frame data included in sensor data on the basis of operation time point information included in home appliance data described above and the relevant matters can be applied to the selecting of a frame data group from a plurality of frame data included in the sensor data on the basis of trigger time point information included in the non-action trigger data (S1230) according to an embodiment, repeated description is omitted.

Further, the determining of training output data on the basis of the non-action trigger data (S1250) according to an embodiment may include determining training output data as a second value corresponding to non-action.

Further, since the determining of training output data on the basis of home appliance data described above and the relevant matters can be applied to the determining of training output data on the basis of the non-action trigger data (S1250) according to an embodiment, repeated description is omitted.

Meanwhile, the method of generating training data can be applied when sensor data includes a plurality of frame data in the above description, but the method of generating training data can also be applied when sensor data includes a plurality of attribute data.

In detail, a method of generating training data according to an embodiment may include obtaining sensor data including a plurality of attribute data, obtaining home appliance data including operation time point information, selecting an attribute data group from attribute data included in the sensor data on the basis of the operation time point information included in the home appliance data, generating training input data on the basis of the selected attribute data group, determining a label value on the basis of the home appliance data, and generating training data by allocating the label value to the training input data.

Accordingly, in the matters described in the method of generating training data using sensor data including a plurality of frame data, matters that can be also applied to the method of training data using sensor data including a plurality of attribute data are not repeatedly described.

Matters that may be different from each other in the method of generating training data using sensor data including a plurality of frame data and the method of training data using sensor data including a plurality of attribute data are described hereafter.

The attribute data according to an embodiment, as described above, may mean data relating to the property of a sub-point dataset such as class information, center position information, size information, shape information, and/or identification information, etc. for a sub-point dataset included in at least one piece of frame data.

In this case, the matters described in the selection of a frame data group from a plurality of frame data included in sensor data on the basis of operation time point information included in home appliance data, the generating of training input data on the basis of the selected frame data group, the determining of a label value on the basis of the home appliance data, and the generating of training data by allocating a label value to the training input data can be applied also to sensor data including a plurality of attribute data.

Meanwhile, all of the pre-processing method in the matters described in relation to pre-processing for a frame data group according to an embodiment may not be applied to an attribute data group. Pre-processing of calculating movement information and/or trajectory information for an attribute data group including attribute data relating to center position information may be performed on an attribute data group according to an embodiment.

Meanwhile, the attribute data according to an embodiment, as described above, may mean data relating to the property of a plurality of sub-point datasets considered as representing a same object in a plurality of frame data such as movement information, identification information, and/or trajectory information for a plurality of sub-point datasets included in a plurality of frame data.

In this case, since one piece of attribute data is determined on the basis of a plurality of frame data, the matters described in the selecting of a frame data group from a plurality of frame data included in sensor data on the basis of operation time point information included in home appliance data may not be applied.

The selecting of attribute data included in sensor data on the basis of operation time point information included in home appliance data may be performed as selecting of attribute data generated on the basis of a plurality of frame data that is earlier than frame data corresponding to a reference time point determined on the basis of operation time point information.

In this case, the reference time point according to an embodiment may be an operation time point according to operation time point information. The reference time point according to an embodiment may be a time point when home appliance data was obtained. The reference time point according to an embodiment may be a time point earlier by a predetermined time from operation time point according to operation time point information. The reference time point according to an embodiment may be a time point earlier by a second time from operation time point according to operation time point information.

Meanwhile, in this case, a plurality of frame data earlier than frame data corresponding to the reference time point according to an embodiment may be frame data before a first time from the frame data corresponding to the reference time point. A plurality of frame data earlier than frame data corresponding to the reference time point according to an embodiment may be frame data before one interval from the frame data corresponding to the reference time point, and is not limited thereto.

Meanwhile, the matters described above in relation to pre-processing of a frame data group according to an embodiment may not be applied when one piece of attribute data is determined on the basis of a plurality of frame data.

Referring to FIG. 3 again, the motion prediction system 400 according to an embodiment may include a training system 420 for training a motion prediction model using the obtained training data 414. The training system 420 according to an embodiment may be a system for generating a trained motion prediction model 422 by training a motion prediction model using the training data 414, and may be implemented by a motion prediction model training module 421.

In this case, since the matters described above can be applied to the motion prediction model, the motion prediction model training module 421, and the trained motion prediction model 422, repeated description is omitted.

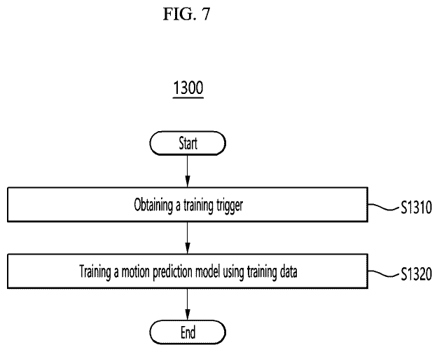

Hereafter, the training system 420 is described in more detail with reference to FIGS. 7 to 9 and then the motion prediction system 400 is described again.

FIGS. 7 to 9 are diagrams illustrating a method of training a motion prediction model according to an embodiment.

Referring to FIG. 7, a method 1300 of training a motion prediction model according to an embodiment may include obtaining a training trigger (S1310) and training a motion prediction model using training data (S1320).

In the obtaining of a training trigger (S1310) according to an embodiment, the training trigger may mean a trigger signal or trigger data for training a motion prediction model using training data obtained by the methods described above.

Further, in the obtaining of a training trigger (S1310) according to an embodiment, the training trigger may be obtained at every preset period.

For example, in the obtaining of a training trigger (S1310) according to an embodiment, the training trigger may be obtained daily at 12 am, but is not limited thereto.

Further, in the obtaining of a training trigger (S1310) according to an embodiment, the training trigger may be obtained in accordance with the number of pieces of obtained training data.

For example, in the obtaining of a training trigger (S1310) according to an embodiment, the training trigger may be obtained when the number of pieces of obtained training data is over a first threshold value, but is not limited thereto.

In more detail, for example, in the obtaining of a training trigger (S1310) according to an embodiment, the training trigger may be obtained when the number of pieces of obtained training data is over 100, but is not limited thereto.

Further, for example, in the obtaining of a training trigger (S1310) according to an embodiment, the training trigger may be obtained when the number of pieces of obtained training data is a multiple of the first threshold value, but is not limited thereto.

In more detail, for example, in the obtaining of a training trigger (S1310) according to an embodiment, the training trigger may be obtained when the number of pieces of obtained training data is a multiple of 100 such as 100, 200, 300, etc., but is not limited thereto.

Further, the training of a motion prediction model (S1320) according to an embodiment may include obtaining training data generated in a training data generation system.

The training of a motion prediction model (S1320) according to an embodiment may include training a non-trained motion prediction model stored in advance.

The training of a motion prediction model (S1320) according to an embodiment may include training a motion prediction model corresponding to each home appliance. For example, it may include training a motion prediction model for predicting an operation of a TV. For example, it may include training a motion prediction model for predicting an operation of a projector, and is not limited thereto.

The training of a motion prediction model (S1320) according to an embodiment may include training a motion prediction model corresponding to each operation type of each home appliance. For example, it may include training a motion prediction model that predicts a turning-on operation of a TV. For example, it may include training a motion prediction model that predicts a turning-off operation of a TV, and is not limited thereto.

The training of a motion prediction model (S1320) according to an embodiment may include training a motion prediction model using training data corresponding to each operation model. For example, it may include training a motion prediction model for predicting an operation of a first home appliance using training data allocated with a label value relating to the first home appliance. For example, it may include training a motion prediction model for predicting an operation of a second home appliance using training data allocated with a label value relating to the second home appliance. For example, it may include training a motion prediction model for predicting a first operation of a first home appliance using training data allocated with a label value relating to the first operation of the first home appliance. For example, it may include training a motion prediction model for predicting a second operation of a first home appliance using training data allocated with a label value relating to the second operation of the first home appliance. For example, it may include training a motion prediction model for predicting a first operation of a first home appliance using training data allocated with a label value relating to the first operation of the first home appliance and training data allocated with a label value corresponding to non-action of the first home appliance.

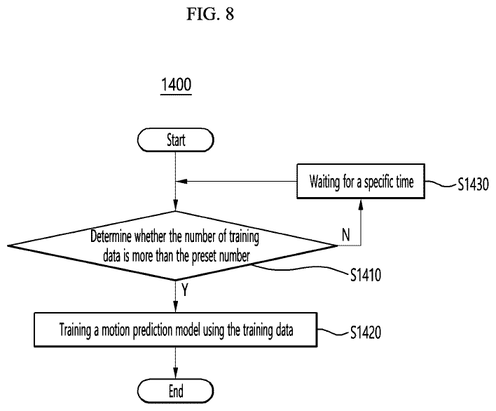

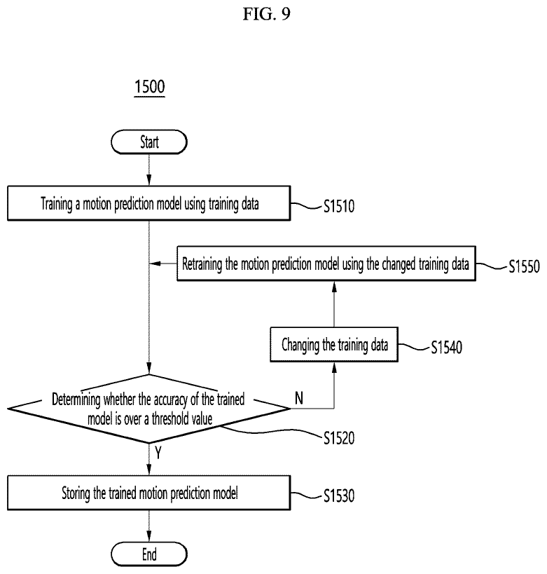

A method of training a motion prediction model is described in more detail with reference to FIGS. 8 and 9.

Referring to FIG. 8, a method 1300 of training a motion prediction model may include determining the number of pieces of training data (S1410), training a motion prediction model using the training data when the number of the pieces of training data is over a preset number (S1420), and waiting for a specific time when the number of the pieces of training data is less than the preset number (S1430).

Since the matters described in the training of a motion prediction model described above can be applied to the training of a motion prediction model using the training data (S1420) according to an embodiment, repeated description is omitted.

The preset number according to an embodiment may depend on the kinds of home appliances corresponding to a motion prediction model. The preset number according to an embodiment may depend on the operation types of home appliances corresponding to a motion prediction model. For example, the preset number may be 10 to 30, but is not limited thereto.

The specific time according to an embodiment may be a preset time interval. For example, the specific time may be one day, and is not limited thereto.

The specific time according to an embodiment may be time until new training data is generated. For example, the specific time may be an average time interval between time points when training data are generated, and is not limited thereto.

The waiting for a specific time according to an embodiment may include determining whether new training data has been generated. In this case, when it is determined that new training data has been generated, the waiting for a specific time can be considered as having been performed.

Meanwhile, referring to FIG. 9, a method 1500 of training a motion prediction model according to an embodiment may include training a motion prediction model using training data (S1510), determining whether the accuracy of the trained model is over a threshold value (S1520), storing the trained motion prediction model when the accuracy of the trained model is over the threshold value (S1530), changing the training data when the accuracy of the trained model is less than the threshold value (S1540), and retraining the motion prediction model using the changed training data (S1550).

Since the matters described above can be applied to the training of a motion prediction model using training data according to an embodiment, repeated description is omitted.

The threshold value according to an embodiment may depend on the kinds of home appliances corresponding to a motion prediction model. The threshold value according to an embodiment may depend on the operation types of home appliances corresponding to a motion prediction model. For example, the threshold value may be 0.7 to 0.9, and is not limited thereto.

The changing of the training data (S1540) according to an embodiment may include obtaining new training data. For example, the changing of the training data (S1540) may include obtaining training data not used in training of the motion prediction model in the training data generated by a training data generation system. For example, the changing of the training data (S1540) may include waiting until new training data is generated, and obtaining newly generated training data.

The changing of the training data (S1540) according to an embodiment may include excluding at least some of training data used in training of the motion prediction model. For example, the changing of the training data (S1540) may include excluding the oldest training data of training data used in training of the motion prediction model.

The retraining of the motion prediction model (S1550) according to an embodiment may include additionally training the motion prediction model trained using the changed training data.

The retraining of the motion prediction model (S1550) according to an embodiment may include training a new motion prediction model using the changed training data.

The method of training a motion prediction model according to an embodiment may be performed in a motion prediction model training module.

Referring to FIG. 3 again, the motion prediction system 400 according to an embodiment may include a prediction system 430 for generating motion prediction information 433 using sensor data 510 obtained from a sensor 500 and the trained motion prediction model 422.

The prediction system 430 according to an embodiment may be a system for generating motion prediction information 433 using sensor data 431 and the trained motion prediction model 422, and may be implemented by the motion prediction module 432.

In this configuration, since the matters described above can be applied to the sensor data 431, the trained motion prediction model 422, the motion prediction information 433, and the motion prediction module 432, repeated description is omitted.

Further, in this configuration, the sensor data 431 may mean some of sensor data 510 obtained from the sensor 500, and may be separately described to specify some of the sensor data 510 that are used to generate the motion prediction information 433 in the prediction system 430 according to an embodiment, but is not limited thereto.

Further, in this configuration, the sensor data 431 may mean sensor data 510 after the trained motion prediction model 422 is trained and/or generated, but is not limited thereto.

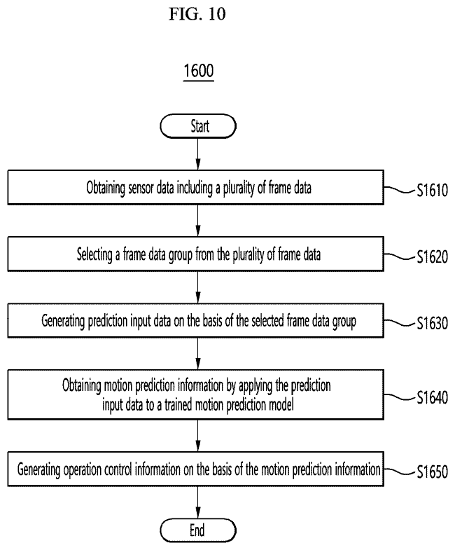

Hereafter, the prediction system 430 is described in more detail with reference to FIGS. 10 to 12 and then the motion prediction system 400 is described again.

FIG. 10 is a diagram illustrating a method of generating operation control information according to an embodiment.

Referring to FIG. 10, a method 1600 of generating operation control information according to an embodiment may include at least one step of obtaining sensor data including a plurality of frame data (S1610), selecting a frame data group from the plurality of frame data (S1620), generating prediction input data on the basis of the selected frame data group (S1630), obtaining motion prediction information by applying the prediction input data to a trained motion prediction model (S1640), and generating operation control information on the basis of the motion prediction information (S1650), but is not limited thereto.

In the obtaining of sensor data including a plurality of frame data (S1610) according to an embodiment, the matters described above in relation to sensor data can be applied to the sensor data including a plurality of frame data, so repeated description is omitted.

Further, in the obtaining of sensor data including a plurality of frame data (S1610) according to an embodiment, the sensor data including a plurality of frame data may include frame data obtained after a trained motion prediction model is trained or generated.

Further, since the matters described above can be applied to the selecting of a frame data group from the plurality of frame data (S1620) according to an embodiment, repeated description is omitted.

Further, in the selecting of a frame data group from the plurality of frame data (S1620) according to an embodiment, the number of pieces of frame data included in the frame data group may be the same as the number of pieces of frame data included in a frame data group for generating training data.

Further, since the generation of training input data on the basis of a selected frame data group and the relevant matters can be applied to the generating of prediction input data on the basis of the selected frame data group (S1630) according to an embodiment, repeated description is omitted.

Further, in the obtaining of motion prediction information by applying the prediction input data to a trained motion prediction model (S1640) according to an embodiment, the prediction input data may be provided in the same format as the training input data described above.

Further, in the obtaining of motion prediction information by applying the prediction input data to a trained motion prediction model (S1640) according to an embodiment, the motion prediction information may be provided as a probability value.

For example, in the obtaining of motion prediction information by applying the prediction input data to a trained motion prediction model (S1640) according to an embodiment, the motion prediction information may be provided as a probability value for TV ON, but is not limited thereto.

Further, in the obtaining of motion prediction information by applying the prediction input data to a trained motion prediction model (S1640) according to an embodiment, the motion prediction information may be provided as a classification value.

For example, in the obtaining of motion prediction information by applying the prediction input data to a trained motion prediction model (S1640) according to an embodiment, the motion prediction information may be provided as a classification value corresponding to TV ON, but is not limited thereto.

Further, in the generating of operation control information on the basis of the motion prediction information (S1650) according to an embodiment, the operation control information may include information for operating a home appliance.

For example, in the generating of operation control information on the basis of the motion prediction information (S1650) according to an embodiment, the operation control information may include information for turning on a TV, but is not limited thereto.

Further, in the generating of operation control information on the basis of the motion prediction information (S1650) according to an embodiment, the operation control information may include information for requesting a response from a user about whether to operate a home appliance.

For example, in the generating of operation control information on the basis of the motion prediction information (S1650) according to an embodiment, the operation control information may include at least one message for selecting whether to operate a TV, but is not limited thereto.

In this case, the at least one message may be output in various ways.

For example, the at least one message may be output through a speaker, a display, etc., and may be output in a way of transmitting at least one piece of information to a user terminal such that the at least one message is output from the user terminal, but is not limited thereto.

Further, in the generating of operation control information on the basis of the motion prediction information (S1650) according to an embodiment, the operation control information may be generated when motion prediction information for continuous input prediction data is classified as a first value over a predetermined number of times.

For example, in the generating of operation control information on the basis of the motion prediction information (S1650) according to an embodiment, the operation control information may be generated when motion prediction information for continuous input prediction data is classified as a value corresponding to TV ON over at least five times, but is not limited thereto.

Further, in this case, the continuous input prediction data may mean prediction input data generated from each of a plurality of continuous frame data groups selected through a sliding window manner.

Further, in the generating of operation control information on the basis of the motion prediction information (S1650) according to an embodiment, the operation control information may be generated when the average value of motion prediction information for continuous input prediction data is over a threshold value.

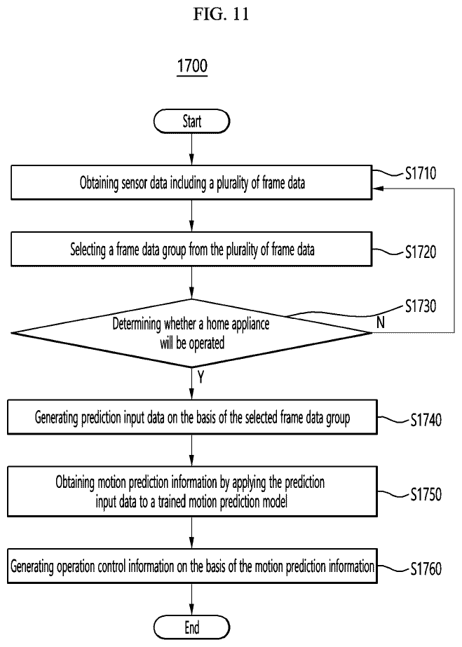

FIG. 11 is a diagram illustrating a method of generating operation control information according to an embodiment.

Referring to FIG. 11, a method 1700 of generating operation control information according to an embodiment may include at least one step of obtaining sensor data including a plurality of frame data (S1710), selecting a frame data group from the plurality of frame data (S1720), determining whether a home appliance will be operated (S1730), generating prediction input data on the basis of the selected frame data group when it is determined that the home appliance will be operated (S1740), obtaining motion prediction information by applying the prediction input data to a trained motion prediction model (S1750), and generating operation control information on the basis of the motion prediction information (S1760), but is not limited thereto.

In the obtaining of sensor data including a plurality of frame data (S1710) according to an embodiment, the matters described above in relation to sensor data can be applied to the sensor data including a plurality of frame data, so repeated description is omitted.

Further, in the obtaining of sensor data including a plurality of frame data (S1710) according to an embodiment, the sensor data including a plurality of frame data may include frame data obtained after a trained motion prediction model is trained or generated.

Further, since the matters described above can be applied to the selecting of a frame data group from the plurality of frame data (S1720) according to an embodiment, repeated description is omitted.

Further, in the selecting of a frame data group from the plurality of frame data (S1720) according to an embodiment, the number of pieces of frame data included in the frame data group may be the same as the number of pieces of frame data included in a frame data group for generating training data.

Further, in the determining of whether a home appliance will be operated on the basis of the selected frame data group (S1730) according to an embodiment, whether a home appliance will be operated may be determined on the basis of the selected frame data group.

Further, in the determining of whether a home appliance will be operated on the basis of the selected frame data group (S1730) according to an embodiment, whether a home appliance will be operated may be determined on the basis of whether a dynamic object is recognized and/or represented in frame data included in the selected frame data group.

Further, in the determining of whether a home appliance will be operated on the basis of the selected frame data group (S1730) according to an embodiment, in relation to whether a home appliance will be operated, it may be determined that the home appliance will be operated when a dynamic object is recognized in frame data included in the selected frame data group.

Further, in the determining of whether a home appliance will be operated on the basis of the selected frame data group (S1730) according to an embodiment, whether a home appliance will be operated may be determined on the basis of whether a dynamic object is recognized in frame data included in the selected frame data group and whether the dynamic object is positioned in a Region Of Interest (ROI).

Further, in the determining of whether a home appliance will be operated on the basis of the selected frame data group (S1730) according to an embodiment, in relation to whether a home appliance will be operated, it may be determined that the home appliance will be operated when a dynamic object is recognized in frame data included in the selected frame data group and the dynamic object is positioned in a Region Of Interest (ROI).

In this case, the ROI may be determined on the basis of the region in which a dynamic object is represented in frame data used to generate training input data used in training of a motion prediction model.

In this case, the ROI may be determined on the basis of the heat map in which a dynamic object is represented in frame data used to generate training input data used in training of a motion prediction model, and is not limited thereto.

Further, since the generation of training input data on the basis of a selected frame data group and the relevant matters can be applied to generating of prediction input data on the basis of the selected frame data group when it is determined that the home appliance will be operated (S1740) according to an embodiment, repeated description is omitted.

Further, in the obtaining of motion prediction information by applying the prediction input data to a trained motion prediction model (S1750) according to an embodiment, the prediction input data may be provided in the same format as the training input data described above.

Further, since the matters described above can be applied to the obtaining of motion prediction information by applying the prediction input data to a trained motion prediction model (S1750) according to an embodiment, repeated description is omitted.

Further, since the matters described above can be applied to the generating of operation control information on the basis of the motion prediction information (S1760) according to an embodiment, repeated description is omitted.

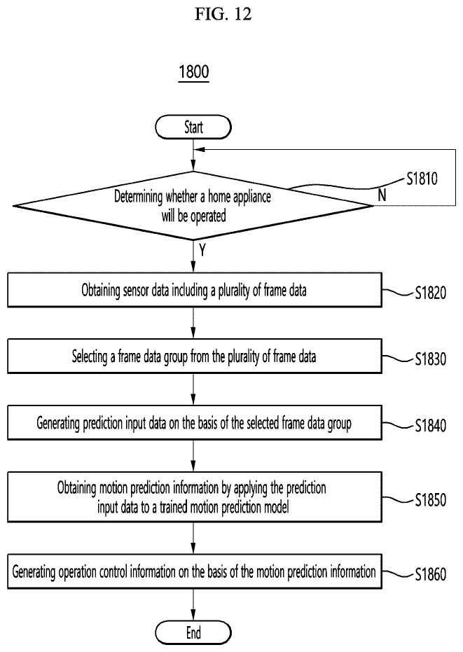

FIG. 12 is a diagram illustrating a method of generating operation control information according to an embodiment.

Referring to FIG. 12, a method 1800 of generating operation control information according to an embodiment may include at least one step of determining whether a home appliance will be operated (S1810), obtaining sensor data including a plurality of frame data when it is determined that the home appliance will be operated (S1820), selecting a frame data group from the plurality of frame data (S1830), generating prediction input data on the basis of the selected frame data group (S1840), obtaining motion prediction information by applying the prediction input data to a trained motion prediction model (S1850), and generating operation control information on the basis of the motion prediction information (S1860), but is not limited thereto.

In the determining of whether a home appliance will be operated on the basis of a selected frame data group (S1810) according to an embodiment, whether the home appliance will be operated may be determined on the basis of a current time point.

Further, in the determining of whether a home appliance will be operated on the basis of a selected frame data group (S1810) according to an embodiment, whether the home appliance will be operated may be determined on the basis of whether the current time point is within an operation time of the home appliance.

Further, in the determining of whether a home appliance will be operated on the basis of a selected frame data group (S1810) according to an embodiment, it may be determined that the home appliance will be operated when the current time point is within the operation time of the home appliance.

In this case, the operation time of the home appliance may be determined on the basis of time points corresponding to frame data used to generate training input data used to train a motion prediction model.

For example, when the time points corresponding to frame data used to generate training input data used to train a motion prediction model are daytime, the operation time of a home appliance may be determined as daytime.

For example, when the time points corresponding to frame data used to generate training input data used to train a motion prediction model are nighttime, the operation time of a home appliance may be determined as nighttime, and are not limited thereto.

Further, in the determining of whether a home appliance will be operated on the basis of a selected frame data group (S1810) according to an embodiment, whether a home appliance will be operated may be determined on the basis of the current state of the home appliance.

Further, in the determining of whether a home appliance will be operated on the basis of a selected frame data group (S1810) according to an embodiment, whether a home appliance will be operated may be determined on the basis of the current state of the home appliance.

Further, in the determining of whether a home appliance will be operated on the basis of a selected frame data group (S1810) according to an embodiment, whether a home appliance will be operated may be determined on the basis of whether the current state of the home appliance is an in-operation state.

Further, in the determining of whether a home appliance will be operated on the basis of a selected frame data group (S1810) according to an embodiment, it may be determined that the home appliance will be operated when the current state of the home appliance is a non-action state.

For example, when a trained motion prediction model is a model that predicts a turning-on operation of a TV and when the current state of a TV is a turned-off state, it may be determined that the turning-on operation of a home appliance will be performed.

Further, in the determining of whether a home appliance will be operated on the basis of a selected frame data group (S1810) according to an embodiment, it may be determined that the home appliance will not be operated when the current state of the home appliance is an in-operation state.

For example, when a trained motion prediction model is a model that predicts a turning-on operation of a TV and when the current state of a TV is a turned-on state, it may be determined that the turning-on operation of a home appliance will not be performed.

Further, in the obtaining of sensor data including a plurality of frame data when it is determined that the home appliance will be operated (S1820) according to an embodiment, the matters described above in relation to sensor data can be applied to the sensor data including a plurality of frame data, so repeated description is omitted.

Further, in the obtaining of sensor data including a plurality of frame data (S1820) according to an embodiment, the sensor data including a plurality of frame data may include frame data obtained after a trained motion prediction model is trained or generated.

Further, since the matters described above can be applied to the selecting of a frame data group from the plurality of frame data (S1830) according to an embodiment, repeated description is omitted.

Further, in the selecting of a frame data group from the plurality of frame data (S1830) according to an embodiment, the number of pieces of frame data included in the frame data group may be the same as the number of pieces of frame data included in a frame data group for generating training data.

Further, since the generation of training input data on the basis of a selected frame data group and the relevant matters can be applied to the generating of prediction input data on the basis of the selected frame data group (S1840) according to an embodiment, repeated description is omitted.

Further, in the obtaining of motion prediction information by applying the prediction input data to a trained motion prediction model (S1850) according to an embodiment, the prediction input data may be provided in the same format as the training input data described above.

Further, since the matters described above can be applied to the obtaining of motion prediction information by applying the prediction input data to a trained motion prediction model (S1850) according to an embodiment, repeated description is omitted.

Further, since the matters described above can be applied to the generating of operation control information on the basis of the motion prediction information (S1860) according to an embodiment, repeated description is omitted.

Referring to FIG. 3 again, the motion prediction system 400 according to an embodiment may further include a version management system 440 for training data and a trained motion prediction model.

A motion pattern of a user interacting with a specific home appliance may change over time.

Accordingly, even though a model that predicts interaction with a specific home appliance on the basis of a motion pattern of a user makes accurate prediction, inaccurate prediction may be frequently generated as the life pattern of the user changes over time.

As a result, the system 440 that manages the versions of training data and a trained motion prediction model may be required to cope with the life patterns of users.

The version management system 440 for training data and a trained motion prediction model according to an embodiment can collect training data even after a trained motion prediction model is generated or trained.

In this case, since the methods of generating training data described above and the relevant matters can be applied to the method in which the version management system 440 for training data and a trained motion prediction model according to an embodiment, repeated description is omitted.

Further, the version management system 440 for training data and a trained motion prediction model according to an embodiment can collect training data on the basis of feedback from a user.

For example, when first motion prediction information generated by applying first prediction input data to a trained motion prediction model is obtained as a value corresponding to TV ON, a TV is turned on, and then a user immediately turns off the TV, the version management system 440 for training data and a trained motion prediction model according to an embodiment can collect training data having the first prediction input data as training input data and having a value corresponding to TV OFF as training output data, but is not limited thereto.

Further, for example, when first motion prediction information generated by applying first prediction input data to a trained motion prediction model is obtained as a value corresponding to TV ON, a message saying whether to operate a TV is output, and a response of a user for the message is negative, the version management system 440 for training data and a trained motion prediction model according to an embodiment can collect training data having the first prediction input data as training input data and having a value corresponding to TV OFF as training output data, but is not limited thereto.

Further, for example, when first motion prediction information generated by applying first prediction input data to a trained motion prediction model is obtained as a value corresponding to TV ON, a TV is turned on, and the TV is not turned off for a predetermined time, the version management system 440 for training data and a trained motion prediction model according to an embodiment can collect training data having the first prediction input data as training input data and having a value corresponding to TV ON as training output data, but is not limited thereto.

Further, for example, when first motion prediction information generated by applying first prediction input data to a trained motion prediction model is obtained as a value corresponding to TV ON, a message saying whether to operate a TV is output, and a response of a user for the message is positive, the version management system 440 for training data and a trained motion prediction model according to an embodiment can collect training data having the first prediction input data as training input data and having a value corresponding to TV ON as training output data, but is not limited thereto.

Further, the version management system 440 for training data and a trained motion prediction model according to an embodiment can manage the version of training data using collected training data.

For example, the version management system 440 for training data and a trained motion prediction model according to an embodiment can manage the version of training data in a way of adding collected training data and deleting training data from older ones such that the number of pieces of training data included in a training dataset is maintained, but is not limited thereto.

Further, for example, the version management system 440 for training data and a trained motion prediction model according to an embodiment can manage the version of training data in a way of adding collected training data such that the number of pieces of training data included in a training dataset is increased, but is not limited thereto.

Further, for example, the version management system 440 for training data and a trained motion prediction model according to an embodiment can manage the version of training data such that the time points when training data included in a training dataset were obtained is within a preset period, but is not limited thereto.

Further, the version management system 440 for training data and a trained motion prediction model according to an embodiment can manage the version of a trained motion prediction model by generating a new trained motion prediction model using updated training data or by retraining a trained motion prediction model.

For example, the version management system 440 for training data and a trained motion prediction model according to an embodiment can generate a new version of trained motion prediction model by training a non-trained motion prediction model using updated training data.

Further, for example, the version management system 440 for training data and a trained motion prediction model according to an embodiment can generate a new version of trained motion prediction model by retraining a trained motion prediction model using updated training data.

Further, the version management system 440 for training data and a trained motion prediction model according to an embodiment can change the version of a motion prediction model when a trigger for managing the version of a motion prediction model is obtained.

For example, when a trigger for managing the version of a motion prediction model is obtained in accordance with a preset period, the version management system 440 for training data and a trained motion prediction model according to an embodiment can generate a new version of trained motion prediction model using updated training data, but is not limited thereto.

In this case, the preset period may be one year, but is not limited thereto.

Further, for example, when the accuracy of a trained motion prediction model is under a threshold value and a trigger for managing the version of a motion prediction model is obtained, the version management system 440 for training data and a trained motion prediction model according to an embodiment can generate a new version of trained motion prediction model using updated training data, but is not limited thereto.

In this case, the threshold value may be 60%, but is not limited thereto.

Further, for example, when the number of pieces of updated training data is over a threshold value and a trigger for managing the version of a motion prediction model is obtained, the version management system 440 for training data and a trained motion prediction model according to an embodiment can generate a new version of trained motion prediction model using updated training data, but is not limited thereto.

Further, for example, when the training data for a new home appliance is obtained and a trigger for managing the version of a motion prediction model is obtained, the version management system 440 for training data and a trained motion prediction model according to an embodiment can generate a new version of trained motion prediction model using updated training data, but is not limited thereto.

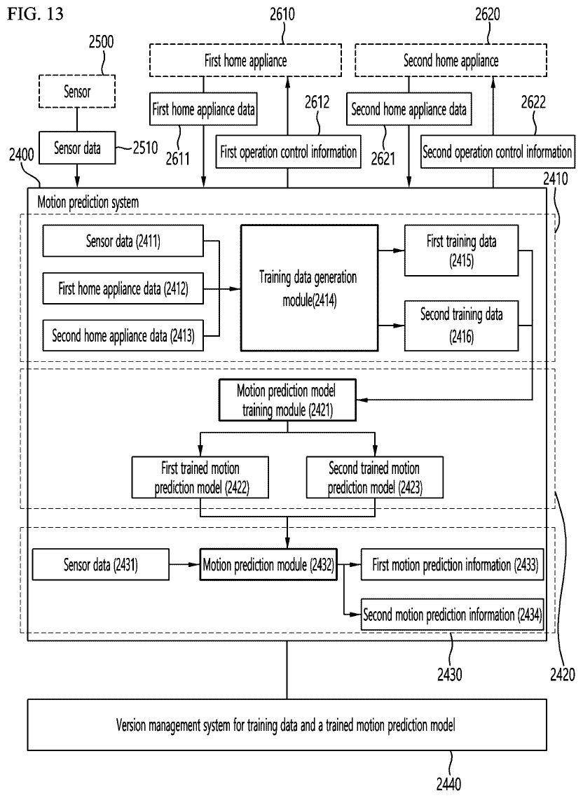

A motion prediction system according to an embodiment is described hereafter with reference to FIGS. 13 to 16.

FIG. 13 is a diagram illustrating a motion prediction system according to an embodiment.

Referring to FIG. 13, a motion prediction system 2400 according to an embodiment may be a system for generating first operation control information 2612 for a first home appliance 2610 and second operation control information 2622 for a second home appliance 2620 on the basis of sensor data 2510 obtained from a sensor 2500.

For example, the motion prediction system 2400 according to an embodiment may be a system for generating turning-on information for a TV or opening information for a refrigerator on the basis of LiDAR information obtained from a LiDAR device, but is not limited thereto.

In this case, since the matters described above can be applied to the sensor 2500 and the sensor data 2510, repeated description is omitted

Further, in this case, since the matters described above in relation to home appliances and operation control information can be applied to the first home appliance 2610, the second home appliance 2620, the first operation control information 2612, and the second operation control information 2622, repeated description is omitted.

Referring to FIG. 13 again, the motion prediction system 2400 according to an embodiment may be a system for training at least one motion prediction model on the basis of sensor data 2510 obtained from the sensor 2500, first home appliance data 2611 obtained from the first home appliance 2610, and second home appliance data 2621 obtained from the second home appliance 2620, and for generating first operation control information 2612 for the first home appliance 2610 and second operation control information 2622 for the second home appliance 2620.

For example, the motion prediction system 2400 according to an embodiment may be a system for training at least one motion prediction model on the basis of LiDAR data obtained from a LiDAR device, TV turning-on information obtained from a TV, and refrigerator opening information obtained from a refrigerator, and for generating turning-on for the TV and opening information for the refrigerator using the trained motion prediction model.

In this case, since the home appliance data described above and the relevant matters can be applied to the first home appliance data 2611 and the second home appliance data 2621, repeated description is omitted.

Referring to FIG. 13 again, the motion prediction system 2400 according to an embodiment may include a training data generation system 2410 for generating at least one piece of training data to train a motion prediction model on the basis of sensor data 2510 obtained from the sensor 2500, first home appliance data 2611 obtained from the first home appliance 2610, and second home appliance data 2621 obtained from the second home appliance 2620.

The training data generation system 2410 according to an embodiment may be a system for generating first training data 2415 and second training data 2416 on the basis of sensor data 2411, first home appliance data 2412, and second home appliance data 2413, and may be implemented by a training data generation module 2414.

In this case, since the matters described above can be applied to the sensor data 2411, the first home appliance data 2412, the second home appliance data 2413, the first training data 2415, the second training data 2416, and the training data generation module 2414, repeated description is omitted.

Further, in this case, the sensor data 2411 may mean some of sensor data 2510 obtained from the sensor 2500, and may be separately described to specify some of the sensor data 2510 that are used to generate the first training data 2415 or the second training data 2416 in the training data generation system 2410 according to an embodiment, but is not limited thereto.

Further, in this configuration, the first home appliance data 2412 may mean some of the first home appliance data 2611 obtained from the first home appliance 2610, and may be separately described to specify some of the first home appliance data 2611 that are used to generate the first training data 2415 in the training data generation system 2410 according to an embodiment, but is not limited thereto.

Further, in this configuration, the second home appliance data 2413 may mean some of the second home appliance data 2621 obtained from the second home appliance 2620, and may be separately described to specify some of the second home appliance data 2621 that are used to generate the second training data 2416 in the training data generation system 2410 according to an embodiment, but is not limited thereto.

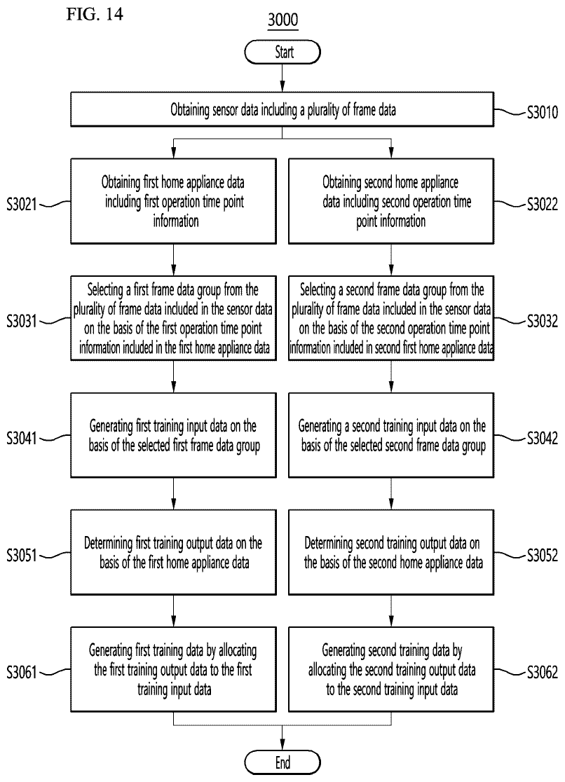

Hereafter, the training data generation system 2410 is described in more detail with reference to FIG. 14 and then the motion prediction system 2400 is described again.

FIG. 14 is a diagram illustrating a method of generating training data according to an embodiment.

Referring to FIG. 14, a method 3000 of generating training data according to an embodiment includes at least one step of obtaining a sensor data including a plurality of frame data (S3010), obtaining first home appliance data including first operation time point information (S3021), obtaining second home appliance data including second operation time point information (S3022), selecting a first frame data group from the plurality of frame data included in the sensor data on the basis of the first operation time point information included in the first home appliance data (S3031), selecting a second frame data group from the plurality of frame data included in the sensor data on the basis of the second operation time point information included in second first home appliance data (S3032), generating first training input data on the basis of the selected first frame data group (S3041), generating a second training input data on the basis of the selected second frame data group (S3042), determining first training output data on the basis of the first home appliance data (S3051), determining second training output data on the basis of the second home appliance data (S3052), generating first training data by allocating the first training output data to the first training input data (S3061), and generating second training data by allocating the second training output data to the second training input data (S3062), but is not limited thereto.

In the obtaining of sensor data including a plurality of frame data (S3010) according to an embodiment, the matters described above in relation to sensor data can be applied to the sensor data including a plurality of frame data, so repeated description is omitted.

Further, in the obtaining of first home appliance data including first operation time point information (S3021) according to an embodiment, the matters described above in relation to home appliance data can be applied to the first home appliance data including first operation time point information, so repeated description is omitted.

Further, in the obtaining of second home appliance data including second operation time point information (S3022) according to an embodiment, the matters described above in relation to home appliance data can be applied to the second home appliance data including second operation time point information, so repeated description is omitted.

In this case, the first home appliance and the second home appliance may be different from each other, and the first home appliance data and the second home appliance may be different from each other.

Further, since the selecting of a frame data group from a plurality of frame data included in the sensor data on the basis of operation time point information included in home appliance data described above and the relevant matters can be applied to the selecting of a first frame data group from the plurality of frame data included in the sensor data on the basis of the first operation time point information included in the first home appliance data (S3031) according to an embodiment, repeated description is omitted.

Further, since the selecting of a frame data group from a plurality of frame data included in the sensor data on the basis of operation time point information included in home appliance data described above and the relevant matters can be applied to the selecting of a second frame data group from the plurality of frame data included in the sensor data on the basis of the second operation time point information included in the second home appliance data (S3032) according to an embodiment, repeated description is omitted.

In this case, the numbers of frame data included in the first frame data group and the second frame data group may be the same.

Further, in this case, the numbers of frame data included in the first frame data group and the second frame data group may be different from each other.

Further, in this case, the numbers of frame data included in the first frame data group and the second frame data group may be different from each other, depending on the kinds of the first home appliance and the second home appliance.

Further, since the generation of training input data on the basis of a selected frame data group described above and the relevant matters can be applied to the generating of first training input data on the basis of the selected first frame data group (S3041) according to an embodiment, repeated description is omitted.

Further, since the generation of training input data on the basis of a selected frame data group described above and the relevant matters can be applied to the generating of second training input data on the basis of the selected second frame data group (S3042) according to an embodiment, repeated description is omitted.

In this case, the formats of the first training input data and the second training input data may be the same as each other.

Further, in this case, the formats of the first training input data and the second training input data may be different from each other.

Further, in this case, the formats of the first training input data and the second training input data may be different from each other, depending on the kinds of the first home appliance and the second home appliance.

Further, in this case, pre-processing for generating the first training input data and pre-processing for generating the second training input data may be the same as each other.

Further, in this case, pre-processing for generating the first training input data and pre-processing for generating the second training input data may be different from each other.

Further, in this case, pre-processing for generating the first training input data and pre-processing for generating the second training input data may be different from each other, depending on the kinds of the first home appliance and the second home appliance.

Further, since the determining of training output data on the basis of home appliance data described above and the relevant matters can be applied to the determining of first training output data on the basis of the first home appliance data (S3051) according to an embodiment, repeated description is omitted.

Further, since the determining of training output data on the basis of home appliance data described above and the relevant matters can be applied to the determining of second training output data on the basis of the second home appliance data (S3052) according to an embodiment, repeated description is omitted.

In this case, the values of the first training output data and the second training output data may be the same as each other.

For example, when first training data and second training data to be described below are used as training data of different classification models, the first training output data and the second training output data both may be a first value or a second value.

Further, in this case, the formats of the first training output data and the second training output data may be different from each other.

For example, when first training data and second training data to be described below are used as training data of a same motion prediction model, the first training output data may be a first value or a second value that relates to an operation of the first home appliance and the second training output data may be a third value or a fourth value that relates to an operation of the second home appliance, but they are not limited thereto.

Further, since the generating of training data by allocating training output data to training input data described above and the relevant matters can be applied to generating of first training data by allocating the first training output data to the first training input data (S3061) according to an embodiment, repeated description is omitted.

Further, since the generating of training data by allocating training output data to training input data described above and the relevant matters can be applied to generating of second training data by allocating the second training output data to the second training input data (S3062) according to an embodiment, repeated description is omitted.

In this case, the first training data and the second training data may be used to train different motion prediction models.

For example, the first training data may be used to train a first motion prediction model for a first home appliance and the second training data may be used to train a second motion prediction model for a second home appliance, but they are not limited thereto.

Further, in this case, the first training data and the second training data may be used to train a same motion prediction model.

For example, the first training data and the second training data may be used to train a motion prediction model for simultaneously predicting operations of a first home appliance and a second home appliance, but are not limited thereto.

Referring to FIG. 13 again, the motion prediction system 2400 according to an embodiment may include a training system 2420 for training at least one motion prediction model using obtained first training data 2415 and second training data 2416.

In this case, the training system 2420 according to an embodiment may be a system for generating a first trained motion prediction model 2422 by training a first motion prediction model using the first training data 2415 and for generating a second trained motion prediction model 2423 by training a second motion prediction model using the second training data 2416, and may be implemented by a motion prediction model training module 2421.

Further, in this case, the training system 2420 according to an embodiment may be a system for generating a trained motion prediction model by training a motion prediction model using the first training data 2415 and the second training data 2416, and may be implemented by the motion prediction model training module 2421.

In this case, since the matters described above can be applied to the motion prediction model, the first motion prediction model, the second motion prediction model, the motion prediction model training module 2421, the trained motion prediction model, the first trained motion prediction model 2422, and the second motion prediction model 2423, repeated description is omitted.

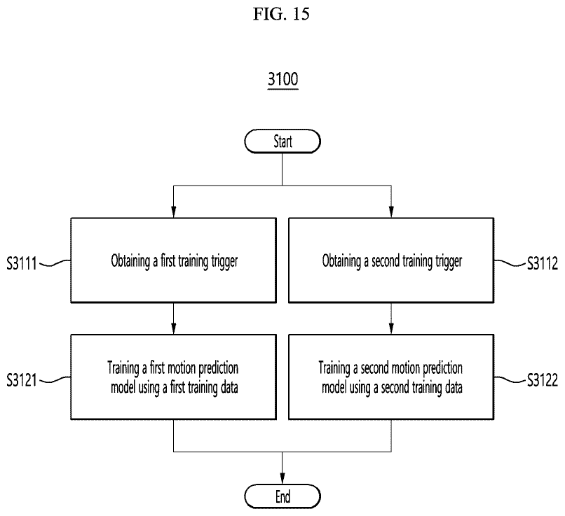

Hereafter, the training system 2420 is described in more detail with reference to FIG. 15 and then the motion prediction system 2400 is described again.

FIG. 15 is a diagram illustrating a method of training a motion prediction model according to an embodiment.

Referring to FIG. 15, a method 3100 of training a motion prediction model according to an embodiment may include at least one step of obtaining a first training trigger (S3111), obtaining a second training trigger (S3112), training a first motion prediction model using first training data (S3121), and training a second motion prediction model using second training data (S3122).

Since the obtaining of a training trigger described above and the relevant matters can be applied to the obtaining of a first training trigger (S3111) according to an embodiment, repeated description is omitted.

Further, since the obtaining of a training trigger described above and the relevant matters can be applied to the obtaining of a second training trigger (S3112) according to an embodiment, repeated description is omitted.

Further, in this case, a first preset period for obtaining the first training trigger may be the same as a second preset period for obtaining the second training trigger.

For example, the first training trigger and the second training trigger may be obtained daily at 12 am, but are not limited thereto.

Further, in this case, the first preset period for obtaining the first training trigger may be different from the second preset period for obtaining the second training trigger.

Further, in this case, the number of pieces of first training data for obtaining the first training trigger may be the same as the number of pieces of second training data for obtaining the second training trigger.

Further, in this case, the number of pieces of first training data for obtaining the first training trigger may be different from the number of pieces of second training data for obtaining the second training trigger.

Further, since the training of a motion prediction model using training data described above and the relevant matters can be applied to the training of a first motion prediction model using first training data (S3121) according to an embodiment, repeated description is omitted.

Further, since the training of a motion prediction model using training data described above and the relevant matters can be applied to the training of a second motion prediction model using second training data (S3122) according to an embodiment, repeated description is omitted.

Further, in this case, the second training data may not be used in training of the first motion prediction model.

Further, in this case, the first training data may not be used in training of the second motion prediction model.

Further, in this case, the first training data may be data relating to a first home appliance and the second training data may be data relating to a second home appliance.

Referring to FIG. 13 again, the motion prediction system 2400 according to an embodiment may include a prediction system 2430 for predicting first motion prediction information 2433 and second motion prediction information 2434 using sensor data 2510 obtained from the sensor 2500, a first trained motion prediction model 2422, and a second trained motion prediction model 2423.

The prediction system 2430 according to an embodiment may be a system for generating first motion prediction information 2433 and second motion prediction information 2434 using sensor data 2431, a first trained motion prediction model 2422, and a second trained motion prediction model 2423, and may be implemented by the motion prediction module 2432.

Further, the prediction system 2430 according to an embodiment may be a system for generating first motion prediction information 2433 and second motion prediction information 2434 using sensor data 2431 and at least one trained motion prediction model, and may be implemented by the motion prediction module 2432.

In this configuration, since the matters described above can be applied to the sensor data 2431, the one trained motion prediction model, the first trained motion prediction model 2422, the second first trained motion prediction model 2423, the first motion prediction information 2433, the second motion prediction information 2434, and the motion prediction module 2432, repeated description is omitted.

Further, in this configuration, the sensor data 2431 may mean some of sensor data 2510 obtained from the sensor 2500, and may be separately described to specify some of the sensor data 2510 that are used to generate the first motion prediction information 2433 and the second motion prediction information 2434 in the prediction system 2430 according to an embodiment, but is not limited thereto.

Further, in this case, the sensor data 2431 may mean sensor data 2510 obtained from the sensor 2500 after the first trained motion prediction model 2422 and the second trained motion prediction model 2423 are trained/generated, but is not limited thereto.

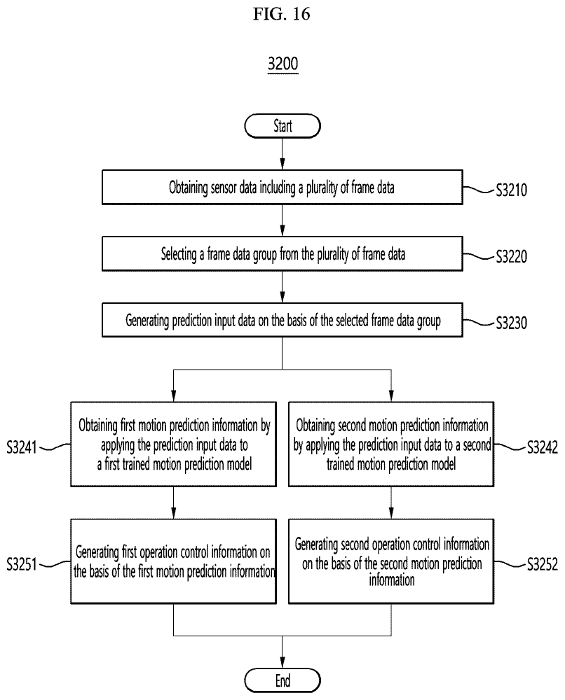

Hereafter, the prediction system 2430 is described in more detail with reference to FIG. 16 and then the motion prediction system 2400 is described again.

FIG. 16 is a diagram illustrating a method of generating operation control information according to an embodiment.

Referring to FIG. 16, a method 3200 of generating operation control information according to an embodiment may include at least one step of obtaining sensor data including a plurality of frame data (S3210), selecting a frame data group from the plurality of frame data (S3220), generating prediction input data on the basis of the selected frame data group (S3230), obtaining first motion prediction information by applying the prediction input data to a first trained motion prediction model (S3241), obtaining second motion prediction information by applying the prediction input data to a second trained motion prediction model (S3242), generating first operation control information on the basis of the first motion prediction information (S3251), and generating second operation control information on the basis of the second motion prediction information (S3252), but is not limited thereto.

In the obtaining of sensor data including a plurality of frame data (S3210) according to an embodiment, the matters described above in relation to sensor data can be applied to the sensor data including a plurality of frame data, so repeated description is omitted.

Further, in the obtaining of sensor data including a plurality of frame data (S3210) according to an embodiment, the sensor data including a plurality of frame data may include frame data obtained after a first trained motion prediction model and a second trained motion prediction model are trained or generated.

Further, since the matters described above can be applied to the selecting of a frame data group from the plurality of frame data (S3220) according to an embodiment, repeated description is omitted.

Further, in the selecting of a frame data group from the plurality of frame data (S3220) according to an embodiment, the number of pieces of frame data included in the frame data group may be the same as the number of pieces of frame data included in a frame data group for generating first training data.

Further, in the selecting of a frame data group from the plurality of frame data (S3220) according to an embodiment, the number of pieces of frame data included in the frame data group may be the same as the number of pieces of frame data included in a frame data group for generating second training data.

Further, since the generation of first training input data on the basis of a selected frame data group and the relevant matters can be applied to the generating of prediction input data on the basis of the selected frame data group (S3230) according to an embodiment, repeated description is omitted.

Further, since the generation of second training input data on the basis of a selected frame data group and the relevant matters can be applied to the generating of prediction input data on the basis of the selected frame data group (S3230) according to an embodiment, repeated description is omitted.

Further, since the obtaining of motion prediction information by applying prediction input data to a trained motion prediction model described above and the relevant matters can be applied to the obtaining of first motion prediction information by applying the prediction input data to a first trained motion prediction model (S3241) according to an embodiment, repeated description is omitted.

Further, since the obtaining of motion prediction information by applying prediction input data to a trained motion prediction model described above and the relevant matters can be applied to the obtaining of second motion prediction information by applying the prediction input data to a second trained motion prediction model (S3242) according to an embodiment, repeated description is omitted.

In this case, the first motion prediction information may be motion prediction information for a first home appliance and the second motion prediction information may be motion prediction information for a second home appliance.

Further, the obtaining of first motion prediction information by applying the prediction input data to a first trained motion prediction model (S3241) according to an embodiment and the obtaining of second motion prediction information by applying the prediction input data to a second trained motion prediction model (S3242) according to an embodiment may be simultaneously performed, but are not limited thereto.

Further, since the generation of operation control information on the basis of motion prediction information described above and the relevant matters can be applied to the generating of first operation control information on the basis of the first motion prediction information (S3251) according to an embodiment, repeated prediction is omitted.

Further, since the generation of operation control information on the basis of motion prediction information described above and the relevant matters can be applied to the generating of second operation control information on the basis of the second motion prediction information (S3252) according to an embodiment, repeated prediction is omitted.

Further, in this case, the first operation control information may be transmitted to a first home appliance and the second operation control information may be transmitted to a second home appliance, but they are not limited thereto.

Further, in the generating of first operation control information on the basis of the first motion prediction information (S3251) according to an embodiment, the first operation control information may include information for operating a first home appliance.

For example, in the generating of first operation control information on the basis of the first motion prediction information (S3251) according to an embodiment, the first operation control information may include information for turning on a TV, but is not limited thereto.

Further, in the generating of second operation control information on the basis of the second motion prediction information (S3252) according to an embodiment, the second operation control information may include information for operating a second home appliance.

For example, in the generating of second operation control information on the basis of the second motion prediction information (S3252) according to an embodiment, the second operation control information may include information for opening a refrigerator, but is not limited thereto.

Referring to FIG. 13 again, the motion prediction system 2400 according to an embodiment may further include a version management system 2440 for training data and a trained motion prediction model.

A motion pattern of a user interacting with a specific home appliance may change over time.

Accordingly, even though a model that predicts interaction with a specific home appliance on the basis of a motion pattern of a user makes accurate prediction, inaccurate prediction may be frequently generated as the life pattern of the user changes over time.

As a result, the system 2440 that manages the versions of training data and a trained motion prediction model may be required to cope with the life patterns of users.

The version management system 2440 for training data and a trained motion prediction model can collect training data even after a first trained motion prediction model and a second trained motion prediction model are generated or trained.

In this case, since the methods of generating training data described above and the relevant matters can be applied to the method in which the version management system 2440 for training data and a trained motion prediction model according to an embodiment, repeated description is omitted.

Further, the version management system 2440 for training data and a trained motion prediction model according to an embodiment can collect training data on the basis of feedback from a user.

For example, when first motion prediction information generated by applying first prediction input data to a first trained motion prediction model is obtained as a value corresponding to TV ON, a TV is turned on, and then a user immediately turns off the TV, the version management system 2440 for training data and a trained motion prediction model according to an embodiment can collect first training data having the first prediction input data as first training input data and having a value corresponding to TV OFF as first training output data, but is not limited thereto.

For example, when second motion prediction information generated by applying second prediction input data to a second trained motion prediction model is obtained as a value corresponding to refrigerator OPEN, a refrigerator is opened, and then a user immediately closes the refrigerator, the version management system 2440 for training data and a trained motion prediction model according to an embodiment can collect second training data having the second prediction input data as second training input data and having a value corresponding to closing of the refrigerator as second training output data, but is not limited thereto.

In this case, references for determining that a user immediately turns off a TV or a user immediately closes a refrigerator may be different from each other.

For example, the time for determining whether a user has immediately turned off a TV may be 10 seconds, but the time for determining whether a user has immediately closed a refrigerator may be 1 second.

Further, for example, when first motion prediction information generated by applying first prediction input data to a first trained motion prediction model is obtained as a value corresponding to TV ON, a message saying whether to operate a TV is output, and a response of a user for the message is negative, the version management system 2440 for training data and a trained motion prediction model according to an embodiment can collect first training data having the first prediction input data as first training input data and having a value corresponding to TV OFF as first training output data, but is not limited thereto.

Further, for example, when second motion prediction information generated by applying second prediction input data to a second trained motion prediction model is obtained as a value corresponding to refrigerator OPEN, a message saying whether to open a refrigerator is output, and a response of a user for the message is negative, the version management system 2440 for training data and a trained motion prediction model according to an embodiment can collect second training data having the second prediction input data as second training input data and having a value corresponding to closing of the refrigerator as second training output data, but is not limited thereto.

Further, for example, when first motion prediction information generated by applying first prediction input data to a first trained motion prediction model is obtained as a value corresponding to TV ON, a TV is turned on, and then the TV is not turned on for a predetermined time, the version management system 2440 for training data and a trained motion prediction model according to an embodiment can collect first training data having the first prediction input data as first training input data and having a value corresponding to TV ON as first training output data, but is not limited thereto.

Further, for example, when second motion prediction information generated by applying second prediction input data to a second trained motion prediction model is obtained as a value corresponding to refrigerator OPEN, a refrigerator is opened, and then the refrigerator is not closed for a predetermined time, the version management system 2440 for training data and a trained motion prediction model according to an embodiment can collect second training data having the second prediction input data as second training input data and having a value corresponding to opening of the refrigerator as second training output data, but is not limited thereto.

In this case, the references of the predetermined time may be different from each other.

For example, the predetermined time for determining whether a TV is not turned off for a predetermined time may be 1 minute and the predetermined time for determining whether a refrigerator is not closed for a predetermined time may be 5 seconds, but they are not limited thereto.

Further, for example, when first motion prediction information generated by applying first prediction input data to a first trained motion prediction model is obtained as a value corresponding to TV ON, a message saying whether to operate a TV is output, and a response of a user for the message is positive, the version management system 2440 for training data and a trained motion prediction model according to an embodiment can collect first training data having the first prediction input data as first training input data and having a value corresponding to TV ON as first training output data, but is not limited thereto.

For example, when second motion prediction information generated by applying second prediction input data to a second trained motion prediction model is obtained as a value corresponding to refrigerator OPEN, a message saying whether to open a refrigerator is output, and a response of a user for the message is positive, the version management system 2440 for training data and a trained motion prediction model according to an embodiment can collect second training data having the second prediction input data as second training input data and having a value corresponding to refrigerator OPEN as second training output data, but is not limited thereto.

Further, since the matters described above can be applied to the version management system 2440 for training data and a trained motion prediction model according to an embodiment, repeated description is omitted.

Hereafter, detailed use scenarios of various motion prediction systems according to the present disclosure are described.

### Scenario of User A

In the home of a user A, at least one LiDAR device may be installed, and a motion prediction system according to an embodiment and a TV that can be controlled by the motion prediction system may be installed. Even after the LiDAR device, the motion prediction system, and the TV are installed in the home of the user A, the user A lives his/her life as usual. The user A, as usual, can operate the TV when he/she wants to watch it, and can turn off the TV when he/she wants to. As the user A turns on and turns off the TV, training data can be collected by the motion prediction system. That is, when the user A operates the TV, corresponding LiDAR data can be collected as training input data and the motion of the user A for the TV can be matched as training output data. As training data are collected for a predetermined time in this way, the motion prediction model included in the motion prediction system can be trained. As time passes, the motion prediction model can be trained to be adapted to the user A. Accordingly, when the motion prediction model predicts TV ON/OFF motions of the user A over a preset level, the prediction system for the user A can be operated thereafter. That is, when it is expected that the user A wants to operate the TV while living his/her life as usual, it is possible to operate the TV or output a question about whether to operate the TV to the user A. Accordingly, the user A can have the amazing experience of the TV operating even by sitting on a sofa to watch the TV. Further, the training data can be managed by the motion prediction system in accordance with feedback from the user A, and accordingly, the system can be more suitably trained even for the changing life pattern of the user A.

### Scenario of User B

In the home of a user B, at least one LiDAR device may be installed, and a motion prediction system according to an embodiment, and a TV, a light, and a refrigerator that can be controlled by the motion prediction system may be installed. After the installation of the LiDAR device, the motion prediction system, the TV, the light, and the refrigerator in the home of the user B, the user B lives his/her life as usual. The user B, as usual, can operate the TV when he/she wants to watch it, and can turn off the TV when he/she wants to. Further, the user B, as usual, can turn on the light too when he/she wants to turn on the light, and can turn off the light when he/she wants to turn off the light. Further, the user B, as usual, can open the door of the refrigerator when he/she wants to take item out of the refrigerator. In this case, as the user B operates the TV, turns of the TV, turns on the light, turns of the light, and opens the door of the refrigerator, training data can be collected by the motion prediction system. That is, as the user B makes motions involving home appliances, corresponding LiDAR data can be collected as training input data, and the motions of the user B on the home appliances can be matched as training output data. As training data are collected for a predetermined time in this way, the motion prediction model included in the motion prediction system can be trained. As time passes, the motion prediction model can be trained to be adapted the user B. In this case, the periods for which respective motion prediction models for the TV, the light, and the refrigerator are adapted to the user B may be different from each other. Accordingly, the prediction system for predicting TV ON/OFF operations may be operated after one month, the prediction system for predicting light ON/OFF operations may be operated after one and a half month, and prediction system for predicting opening of the refrigerator may be operated after three months. That is, the user B can have an experience that he/she receives questions about turning on/off the TV from the motion prediction system or the TV is automatically turned on/off after about one month while living his/her life as usual. Further, after fourteen days have passed while the user B has an amazing experience with the TV, the user B can have an experience that he/she receives questions about turning on/off the light from the motion prediction system or the light is automatically turned on/off. Further, after one and a half months, the user B can have an experience that he/she receives a question about whether to open the refrigerator or the refrigerator automatically opens. Accordingly, the user can have an amazing experience that the motion prediction system is increasingly adapted to himself/herself over time.

### Scenario of User C

A user C lives with a pet, uses a feeder and a water supplier to adjust feeding and water supplying for the pet, and uses a toy for playing with the pet. In the home of the user C, at least one LiDAR device can be installed, and a motion prediction system and a feeder and a water supplier that can be controlled by the motion prediction system may be installed. Even after the installation of the LiDAR device, the motion prediction system, the feeder, the water supplier, and the toy in the home of the user C, the user C lives his/her life as usual. That is, the user C may replenish the feeder with the feed for the pet before the feed for the pet runs out, supplement feed in accordance with specific actions of the pet, replenish the water supplier with water for the pet before the water for the pet runs out, and supplement water in accordance with specific actions of the pet. Further, the user may operate the toy or turn off the toy in accordance with specific actions of the pet. As the user C makes motions involving the feeder, water supplier, and toy, training data can be collected by the motion prediction system. That is, as the user C makes motions involving home appliances, corresponding LiDAR data can be collected as training input data, and the motions of the user C on the home appliances can be matched as training output data. In this case, the user C or the pet of the user C may be represented in the LiDAR data collected as training input data. As training data are collected for a predetermined time in this way, the motion prediction model included in the motion prediction system can be trained. As time passes, the motion prediction model can be trained to be adapted to the user C. That is, accordingly, the reactions of the user C to specific actions of the pet of the user C can be learned. That is, if the user C has operated the feeder for a specific action 1 of the pet of the user C, operation of the feeder can be predicted by the motion prediction system when the pet of the user C takes the specific action 1. Accordingly, as time further passes, the pet of the user C and the motion prediction system can be further trained for each other, and the user C can have an amazing experience that the feeder, the water supplier, and the toy are automatically operated in response to actions of the pet of the user C even though the user C does not move.

### Scenario of User D

In the office space of a user D, at least one LiDAR device may be installed, and a motion prediction system according to an embodiment, and a fax machine, a printer, and a beam projector that can be controlled by the motion prediction system may be installed. Even after the installation of the LiDAR device, the motion prediction system, the fax machine, the printer, and the beam projector in the office space of the user D, the user D performs his office tasks as usual. The user D can operate the fax machine, as usual, when he/she needs to send a fax. Further, the user D can warm up the printer as well, as usual, when he/she needs to print data. Further, the user D, as usual, can turn on the beam projector when preparing for a conference, and can turn off the beam project after the conference. In this case, as the user D operates the fax machine, warms up the printer, turns on the beam projector, and turns off the beam projector, training data can be collected by the motion prediction system. That is, as the user D makes motions involving office equipment, corresponding LiDAR data can be collected as training input data, and the motions of the user D on the office equipment can be matched as training output data. As training data are collected for a predetermined time in this way, the motion prediction model included in the motion prediction system can be trained. As time passes, the motion prediction model can be trained to be adapted to the user D. In this case, the periods for which respective motion prediction models for the fax machine, the printer, and the beam projector may be different from each other. Accordingly, for example, the prediction system for motion prediction of the fax machine may be operated after one month, the prediction system for warming-up of the printer may be operated after two months, and the prediction system for turning-on/off of the beam projector may be operated after three months. That is, the user D can have an experience that he/she receives a question about whether to start the fax machine from the motion prediction system or the fax machine automatically operates after about one month while he/she performs his/her office tasks as usual. Further, after one month passes while the user D has an amazing experience with the fax machine, the user can have an experience that he/she receives a question about whether to warm up the printer from the motion prediction system or the printer automatically warms up. Further, after one month passes, the user D can have an experience that he/she receives a question about whether to turn on/off the beam projector from the motion prediction system or the beam projector automatically turns on/off. Accordingly, the user D can have an experience of an increase of the work efficiency with the amazing experience that the motion prediction system is increasingly adapted to himself/herself over time.

The method according to an embodiment may be implemented in a program that can be executed by various computers and may be recorded on computer-readable media. The computer-readable media may include program commands, data files, and data structures individually or in combinations thereof. The program commands that are recorded on the media may be those specifically designed and configured for the present invention or may be those available and known to those engaged in computer software in the art. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter etc. The hardware device may be configured to operate as one or more software modules to perform the operation of the present invention, and vice versa.

Embodiments were described above with reference to the limited examples and drawings, but they may be changed and modified in various ways by those skilled in the art. For example, the described technologies may be performed in order different from the described method, and/or even if components such as the described system, structure, device, and circuit are combined or associated in different ways from the description or replaced by other components or equivalents, appropriate results can be accomplished.

Therefore, other implements, other embodiments, and equivalents to the claims are included in the following claims.

What is claimed is:

1. A method for training a motion prediction model, comprising:
obtaining a sensor data comprising a plurality of frame data, wherein the sensor data comprises time information for each of the plurality of frame data, wherein each of the plurality of frame data comprises a plurality of point data, and wherein each of the plurality of point data comprises a position coordinate value;
obtaining a first home appliance data comprising operation time information for a first operation of a first home appliance;
selecting a first frame data group based on the operation time information for the first operation of the first home appliance included in the first home appliance data and the time information for each of the plurality of frame data, wherein the first frame data group comprises at least two or more frame data, and wherein time information for the at least two or more frame data included in the first frame data group indicates times earlier than the operation time information for the first operation;
generating a first training input data for the first operation of the first home appliance based on the first frame data group; and
training a first motion prediction model for the first home appliance using at least the first training input data.

2. The method of claim 1, wherein the sensor data includes at least one of point cloud data, depth map data, intensity map data, light capture map data, or detecting map data.

3. The method of claim 1, wherein the operation time information for the first operation of the first home appliance is time information determined based on at least one of a time when the first home appliance starts interacting with the user, a time when the first home appliance is warming-up by interacting with the user, a time when the first home appliance interacts with the user and starts the first operation, a time when the first home appliance completes the first operation, or a time interval during which the home appliance interacted with the user.

4. The method of claim 1, further comprising:
obtaining a second home appliance data comprising operation time information for a second operation of a second home appliance;
selecting a second frame data group based on the operation time information for the second operation of the second home appliance included in the second home appliance data and the time information for each of the plurality of frame data, wherein the second frame data group comprises at least two or more frame data, and wherein time information for the at least two or more frame data included in the second frame data group indicates times earlier than the operation time information for the second operation;
generating a second training input data for the second operation of the second home appliance based on the second frame data group; and
training a second motion prediction model for the second home appliance using at least the second training input data.

5. The method of claim 1, wherein selecting the first frame data group comprises:
specifying a reference time point based on the operation time for the first operation; and
selecting, among the plurality of frame data, a first frame data corresponding to a first time point that is earlier than the reference time point to an N-th frame data corresponding to an N-th time point that is earlier than the reference time point.

6. The method of claim 1, wherein selecting the first frame data group comprises:
specifying a reference time point based on the operation time for the first operation;
specifying a specific time period based on the reference time point; and
selecting, among the plurality of frame data, frame data corresponding to the specific time period.

7. The method of claim 6, wherein the specific time period comprises a time period between the reference time point and a time point before a first predetermined time period from the reference time point.

8. The method of claim 6, wherein the specific time period comprises a time period between a time point before a first predetermined time period from the reference time point and a time point before a second predetermined time period from the reference time point.

9. The method of claim 1, wherein generating the first training input data for the first operation of the first home appliance based on the first frame data group comprises:
segmenting, for each of the frame data included in the first frame data group, at least some sub-point data corresponding to dynamic object among the point data included in the frame data;
obtaining center position information corresponding to each of the frame data based on a position coordinate value of the segmented sub-point data; and
generating the first training input data for the first operation of the first home appliance based on the obtained center position information.

10. The method of claim 9, wherein generating the first training input data for the first operation of the first home appliance based on the obtained center position information comprises:
obtaining trajectory information for the center position information based on a position coordinate of the obtained center position information; and
generating the first training input data for the first operation of the first home appliance based on the trajectory information.

11. The method of claim 1, further comprising:
obtaining a non-action trigger data for the first home appliance;
selecting a third frame data group based on trigger time information included in the non-action trigger data and the time information for each of the plurality of frame data, wherein the third frame data group comprises at least two or more frame data;
generating a third training input data for a non-action of the first home appliance based on the third frame data group; and
training the first motion prediction model for the first home appliance further using the third frame data group.

12. The method of claim 1, wherein training the first motion prediction model for the first home appliance using at least the first training input data comprises:
obtaining a training trigger; and
training the first motion prediction model for the first home appliance using the first training input data.

13. The method of claim 1, wherein training the first motion prediction model for the first home appliance using at least the first training input data comprises:
determining the number of the first training input data;
training the first motion prediction model for the first home appliance suing the first training input data when the number of the first training input data is more than a predetermined number; and
waiting for a specific time when the number of the first training input data is less than the predetermined number.

14. A method for operating a motion prediction system that generates motion control information for home appliances after a training data collection period once installed in a user's home, the method comprising:
generating a trained motion prediction model, wherein the trained motion prediction model is trained using training data generated based on sensor data obtained in the training data collection period; and
generating operation control information for the home appliances by applying prediction input data to the trained operation prediction model, wherein the prediction input data is generated based on sensor data obtained in an operation prediction period after the training data collection period;
wherein in the training data collection period, the motion prediction system operates by:
obtaining sensor data comprising a plurality of frame data, wherein each of the plurality of frame data comprises a plurality of point data, and wherein each of the plurality of point data comprises a position coordinate value;
obtaining a home appliance data comprising operation time information for a first operation of the home appliances;
selecting a first frame data group comprising at least two or more frame data among the plurality of frame data using the operation time information for the first operation of the home appliances included in the home appliance data; and
generating a training data by generating a training input data for the first operation of the home appliances based on the first frame data group,
wherein in the operation prediction period, the motion prediction system operates by:
obtaining sensor data comprising a plurality of frame data, wherein each of the plurality of frame data comprises a plurality of point data, wherein each of the plurality of point data comprises a position coordinate value;
selecting a second frame data group comprising at least two or more frame data among the plurality of frame data;
generating a prediction input data based on the second frame data group; and
generating an operation control information for the home appliances by applying the prediction input data to the trained motion prediction model.

15. The method of claim 14, wherein generating the training data by generating the training input data for the first operation of the home appliances based on the first frame data group comprises:
generating the training input data for the first operation of the home appliances by performing a first pre-processing on the first frame data group,
wherein generating a prediction input data based on the second frame data group comprises:
generating the prediction input data by performing a second pre-processing on the second frame data group, and
wherein the first pre-processing and the second pre-processing include the same pre-processing algorithm.

16. The method of claim 14, wherein the number of frame data included in the second frame data group is the same as the number of frame data included in the first frame data group.

17. The method of claim 14, wherein selecting the first frame data group comprises:
specifying a reference time point based on the operation time for the first operation; and
selecting, among the plurality of frame data, a first frame data corresponding to a first time point that is earlier than the reference time point to an N-th frame data corresponding to an N-th time point that is earlier than the reference time point.

18. The method of claim 14, wherein selecting the first frame data group comprises:
specifying a reference time point based on the operation time for the first operation;
specifying a specific time period based on the reference time point; and
selecting, among the plurality of frame data, frame data corresponding to the specific time period.

19. The method of claim 18, wherein the specific time period comprises a time period between the reference time point and a time point before a first predetermined time period from the reference time point.

20. The method of claim 18, wherein the specific time period comprises a time period between a time point before a first predetermined time period from the reference time point and a time point before a second predetermined time period from the reference time point.

21. The method of claim 14, wherein generating the prediction input data based on the second frame data group comprises:
determining whether the home appliances will operate; and
generating the prediction input data based on the second frame data group when it is determined that the home appliances will be operated.

22. The method of claim 21, wherein determining whether the home appliances will operate comprises:
determining whether the home appliances will operate based on whether a dynamic object appears in at least one of the frame data included in the second frame data group.

23. The method of claim 14, wherein the operation control information comprises information for requesting a user's response whether the home appliances are operating.

24. The method of claim 14, wherein generating the operation control information for the home appliances by applying the prediction input data to the trained motion prediction model comprises:
obtaining continuous motion prediction information by applying continuously obtained prediction input data to the trained motion prediction model; and
generating the operation control information when the obtained motion prediction information are classified as a first value more than a predetermined number of times.
